(19) United States
(12) Patent Application Publication
(10) Pub. No.: US 2009/0144302 A1
(43) Pub. Date: Jun. 4, 2009

(54) WEB APPLICATION FOR ARGUMENT MAPS

(76) Inventor: PETER JEREMY BALDWIN, Blackheath (AU)

Correspondence Address: STETINA BRUNDA GARRED & BRUCKER, 75 ENTERPRISE, SUITE 250, ALISO VIEJO, CA, 92656, US

(21) Appl. No.: 12/338,819

(22) Filed: Dec. 18, 2008

Related U.S. Application Data
(63) Continuation of application No. 11/543,489, filed on Oct. 5, 2006, now abandoned.

(30) Foreign Application Priority Data
Apr. 5, 2004 (AU) 2004901817
Aug. 19, 2004 (AU) 2004904849

(51) Int. Cl. G06F 17/30

(52) U.S. Cl. 707/100; 707/E17.127

(57) ABSTRACT

A fully web-enabled method for diagrammatically representing the meaningful structure of a complex argument or debate, or other similar information, as a schematic map made up of nodes each of which represent a discrete element in said meaningful structure . The method includes beginning a new map by specifying the broad subject matter and other data about the map and selecting from one of a plurality of sets of encoded information and rules, termed Map Grammars, that constrain how nodes of different types may be combined to form maps and the actions available to persons building. The method further includes editing or otherwise interacting with such maps. The method also includes associating selected information items relevant to the argument or debate with map nodes. The method also includes adding nodes to the schematic map in such a way as to form an overall structure in which nodes are organized so as to conform to the Map Grammar at all times.

The present invention relates to a method and a computer program package including programming instructions for performing a method for structurally and semantically organizing information associated with an argument into the form of a debate map or argument map and more particularly a fully web enabled method and package.

### BACKGROUND

The volume of information available to persons in the early 21^{st} century through a variety of means including the Internet, books, journal articles or other multimedia sources creates a problem of information overload. Persons in a domestic, technical, commercial or educational environment are obliged on a daily basis to analyze information and to put forward reasoned arguments associated with analysis. The process of effective decision making or effective analysis of information presented to people is clouded by the inclusion of material which is seemingly irrelevant to their purposes.

One effective means for dealing with the above challenge, which is presented herein, is to map the essential or core structure of arguments and information so as to distill out only so much of the information as is necessary to make effective decisions.

The process and the subject of this patent achieves this end by way of enabling the user to identify, in graphical form key elements of an argument and to associate those elements, at a point in the data called a node point with various indicia or identifiers, which include the content of the information and rules of grammar which may govern the use of the information, i.e. who can access it and what they can do with it (actions to be taken) and what other child nodes may exist below the node in question (thereby defining the tree hierarchy within the data). Labeling of data is also assisted by way of identification of metadata such as the name of the evaluator (the person(s) who evaluated the data) and the date of evaluation.

By creating nodes of key or core information and by linking such nodes together in tree structure information within arguments can be schematically and semantically mapped so as to minimize the information load placed upon the users the data.

It is an object of this present invention to address or at least ameliorate some of the disadvantages presented above.

### BRIEF DESCRIPTION OF THE INVENTION

Accordingly, in one broad form of the invention, there is provided a web-enabled method for diagrammatically representing the meaningful structure of a complex argument or debate, or other similar information, as a schematic map made up of nodes each of which represent a discrete element in said meaningful structure.

Accordingly, in a further broad form of the invention, there is provided a computer program package including programming instructions for implementing a fully web-enabled process for diagrammatically representing the meaningful structure of a complex argument or debate, or other similar information, as a schematic map made up of nodes.

Accordingly, in a further broad form of the invention, there is provided a fully web-enabled method for diagrammatically representing the meaningful structure of a complex argument or debate, or other similar information, as a schematic map made up of nodes each of which represent a discrete element in said meaningful structure comprising the steps of:
a. Beginning a new map by specifying the broad subject matter and other data about said map and selecting from one of a plurality of sets of encoded information and rules, termed Node Grammars, that constrain how nodes of different types may be combined to form maps and the actions available to persons building or otherwise interacting with said maps.
b. Associating selected information extracted from said argument or debate, or other information, with said nodes.
c. Adding nodes to said schematic map in such a way as to form an overall structure in which information is organized as a tree-hierarchy of arbitrary depth and size in such a way that the rules of said Node Grammar are complied with at all times.

Preferably for each node, a set of node data is stored and maintained concerning the semantic content of the node, metadata about the node, and data concerning the relation between the node and other nodes in a map structure.

Preferably each of said nodes belongs to one of a plurality of classes of said nodes where members of each node class have a specified semantic or functional relationship to other nodes in a schematic map and each node class has a set of characteristics that determine how it is displayed within the context of a schematic map.

Preferably at all times, the map conforms to a set of grammatical rules which constrain how nodes of different classes may be combined in relation to each other to form a map.

Preferably the user of a map is at all times presented only with a permitted set of actions for building and editing, or otherwise interacting with, the map and its constituent nodes and any other information and resources that are associated with the map and its constituent nodes.

Preferably information about the:
a. Node classes.
b. Grammatical rules.
c. Permitted actions
   is encoded and saved in an electronic format made up of one or more special electronic documents, such encoded information being termed a Node Grammar.

Preferably Node Grammar uses a special web interface designed for this purpose.

Preferably the Node Grammar may be applied to a map made up of entirely new node data, or applied to pre-existing node data associated with an existing map.

Preferably each said schematic map is uniquely specified by:
a. A set of node data as recited in any of the above claims.
b. A Node Grammar

Preferably particular classes of users may designate a map as private, public or administrator-only access.

Preferably for any map, evaluation of nodes, evaluation of resources associated with nodes, and marketing of resources can be enabled or disenabled by users with the appropriate permission.

Preferably for each node, the meaningful content of said node may be expressed in a plurality of ways varying in format and level of detail.

Preferably users may readily select and display one or more of the plurality of expressions of a node's meaningful content as recited above

Preferably a number of such maps are together organized as a repository of maps, with the entire such repository organized as a superposing map having a similar structure as each constituent map in said repository.

Preferably users may build and edit maps using a plurality of methods, including:
a. Adding new nodes.
b. Editing existing nodes.
c. Deleting or permanently deleting nodes.
d. Moving a designated node and any tree-structure made up of other nodes sitting below said designated node in the map tree hierarchy, herein referred to as the subtree, to a different location in the same map as said designated node, or to a location in different map, subject to any constraints encoded in any applicable Node Grammars applying to the maps containing the origin and destination of the moved node.
e. Copying a designated node and its subtree to a different location in the same map as said designated node, or to a location in different map, subject to any constraints encoded in any applicable Node Grammars applying to the maps containing the origin and destination of the moved node.
f. Inserting subtrees into selected locations in maps from source files encoded using Extensible Markup Language (XML).
g. Inserting cross-references to other nodes within any map in the containing repository of maps.
h. Adding a special class of node that can be used to filter information displayed in a map in accordance with a stated rationale.
i. Book-marking selected nodes.
j. Adding a special class of node which is invisible to users other than the node author, and any subtree of which is likewise invisible.

Preferably a user attempting to execute such moving action is prevented from carrying out such action if it would result in any nodes being isolated from a map structure.

Preferably a user can provide one, and no more than one at any particular time, numerical evaluation of the significance of a node.

Preferably for each node, a count is automatically maintained of the number of users who have evaluated the node, and the average evaluation by all such users.

Preferably a user may conduct full text searches of nodes and resources and go to any node or resource returned by such searches.

Preferably a user is able to selectively retrieve and display map information using a plurality of methods, including the following:
a. Selecting a particular node in a map and retrieving node data to a specified depth below it in the tree structure.
b. Repeating the method of in relation to any displayed nodes to retrieve and display as much of the map node data as desired.
c. Repositioning on a map so that the displayed map portion begins at any node selected by the user, with the selected node's subtree retrieved to a specified depth.
d. Repositioning the map to the parent node of a selected node.
e. Repositioning a map display so that the displayed map portion begins at a bookmarked node in any map within the containing repository of maps.
f. Repositioning a map display by jumping to a cross-referenced node within the containing repository of maps.
g. Repositioning a map display by jumping to a node retrieved by a full text search of nodes.
h. Retracing any steps using a special set of navigation controls.
i. Restarting a map viewing session by retrieving and displaying the same set of data as when a map is initially displayed.
j. Filtering out specified classes of nodes.
k. Filtering out selected nodes and their sub-trees in accordance with a stated rationale.
l. Choosing from a plurality of options stipulating how map nodes having the same parent node in the tree structure are ordered in a map display.
m. Filtering out from a displayed map, or portion of a map, all nodes with an average evaluated significance below some value selected by the user.
n. Selecting from a plurality of other map filtering criteria, including node authorship and node creation date.

Preferably structured node data may be saved in an XML format, or inserted into a map from an XML document.

Preferably a map view may be rendered and saved in a linear document format.

Preferably data about maps, map nodes, resources and sub-resources, users and permissions may be displayed in tabular formats.

Preferably a distinctive web interface is displayed for building, editing, and navigating around maps and for viewing data for each node, and information about resources associated with each node.

Preferably the user may choose to display one of a plurality of sub-panels, each providing different functionality, including:
a. A long, formatted text of each node's semantic content.
b. A panel for customizing how and which information is displayed on a map view.
c. A panel for performing full-text searches of nodes and of resources associated with nodes.
d. A panel for evaluating nodes.
e. Information about the grammar and rules for the displayed map.
f. Information about credentialed users of the displayed map.
g. A panel showing instructions and assistance to the user.

Preferably the user can choose from a plurality of overall interface formats, including different options for the map display size and width of text columns.

Preferably access to all functionality is governed by a role-based permission system.

Preferably two sets of roles are provided governing respectively:
a. Actions that pertain to the entire repository of maps and associated resources.
b. Actions that pertain to any specific map and its associated resources.

Preferably for each user, information is stored and maintained concerning:
a. The user's role in relation to the entire repository of maps and associated resources.
b. The user's role in relation to one or more particular maps.

Preferably persons may apply for permissions in relation to the entire repository of maps and resources, and for one or more particular maps, and apply for changes to any existing permission levels.

Preferably interfaces are provided enabling users to apply for any new roles, or to apply to change any existing roles.

Preferably additional information items, herein termed resources, or specified subsets of such resources, may be associated with map nodes. Such resources may include: online articles and papers; electronic books; web sites; images, videos and other multimedia items and structured multimedia presentations; query results and other services; or any other information or service that can be addressed using a Uniform Resource Identifier (URI).

Preferably using special interfaces for textual and multimedia resources respectively and of encoding and storing such subset specifications for future viewing of said subsets in conjunction with maps.

Accordingly, in a further broad form of the invention there is provided a method of uploading resources in a variety of formats from a user's computer to a server in order that they may be associated with a specified map node.

Preferably a method of converting uploaded resources in certain specified formats to a different format suitable for rendition on the web and for selection of subsets.

Preferably a method whereby each user may manage any resources are uploaded by said user, as well as any files derived from such uploaded resources, or files saved in the course of a map browsing session by said user.

Preferably web interfaces are constructed to enable users to associate resources and subsets of resources with particular nodes and to provide additional information about such resources or sub-resources and to upload any resources.

Preferably users may evaluate the significance of any resources associated with map nodes.

Preferably users may view tables of information about resources associated with map nodes ordered by average evaluated significance or by any other user-specified ordering criteria.

Preferably a method of displaying information about resources using a special interface.

Preferably a method of displaying resources in any of the above using a plurality of formats, including formats suitable for web browsers, media players and electronic book reading software.

Preferably items, or collations of items, may be offered for sale by users having the appropriate permission using a marketing system.

Preferably a user offering an item for sale may specify information about the price and characteristics of the item, as well as graphic images for display advertising and web addresses for further information.

Preferably marketed items may be offered for sale in conjunction with map nodes and resources or sub-resources that have been associated with said nodes.

Preferably users may accumulate purchases of said marketed items during a session browsing maps and resources in an electronic shopping cart and proceed to a checkout page to finalize said purchases.

Preferably the argument mapping method as recited above wherein administration methods will control:
a. Generic administration activities which include: repositories of maps, resources, users and granting of permission in relation to access and the execution of actions associated with any map.
b. Map-specific administration which includes: node data, resources, and the allocating of permitted uses of a specific map.

Preferably an online help system is available while using any of the functionality.

Preferably different groups of users may add or edit material in different parts of the help system, including private or public annotations, queries, comments, cross-references, filters and discussion threads.

Preferably different classes of user have different rights to edit and otherwise interact with said help system depending on their permission levels.

Preferably all maps and resources and all functionality described in the above claims may be accessed through the World Wide Web using browsers and media players.

Preferably data in relation to maps, nodes, resources, sub-resources, users and permissions is stored and maintained in a relational database.

Preferably the said mapping method may be applied to other types of information, in addition to argument maps, including documentation building systems and taxonomical structures.

Accordingly, in a further broad form of the invention, there is provided a computer program package including programming instructions for implementing a fully web-enabled process for diagrammatically representing the meaningful structure of a complex argument or debate, or other similar information, as a schematic map made up of nodes each of which represent a discrete element in said meaningful structure comprising the steps of:
a. Beginning a new map by specifying the broad subject matter and other data about said map and selecting from one of a plurality of sets of encoded information and rules, termed Node Grammars, that constrain how nodes of different types may be combined to form maps and the actions available to persons building or otherwise interacting with said maps.
b. Associating selected information extracted from said argument or debate, or other information, with said nodes.
c. Adding nodes to said schematic map in such a way as to form an overall structure in which information is organized as a tree-hierarchy of arbitrary depth and size in such a way that the rules of said Node Grammar are complied with at all times.

Accordingly, in a further broad form of the invention, there is provided a digitized media package for implementing a fully web-enabled process for diagrammatically representing the meaningful structure of a complex argument or debate, or other similar information, as a schematic map made up of nodes each of which represent a discrete element in said meaningful structure comprising the steps of:
a. Beginning a new map by specifying the broad subject matter and other data about said map and electing from one of a plurality of sets of encoded information and rules, termed Node Grammars, that constrain how nodes of different types may be combined to form maps and the actions available to persons building or otherwise interacting with said maps.
b. Associating selected information extracted from said argument or debate, or other information, with said nodes
c. Adding nodes to said schematic map in such a way as to form an overall structure in which information is organized as a tree-hierarchy of arbitrary depth and size in such a way that the rules of said Node Grammar are complied with at all times.

Accordingly, in a further broad form of the invention, there is provided a digitized system for implementing a fully web-enabled process for diagrammatically representing the meaningful structure of a complex argument or debate, or other similar information, as a schematic map made up of nodes each of which represent a discrete element in said meaningful structure comprising the steps of:
a. Beginning a new map by specifying the broad subject matter and other data about said map and selecting from one of a plurality of sets of encoded information and rules, termed Node Grammars, that constrain how nodes of different types may be combined to form maps and the actions available to persons building or otherwise interacting with said maps.
b. Associating selected information extracted from said argument or debate, or other information, with said nodes.
c. Adding nodes to said schematic map in such a way as to form an overall structure in which information is organized as a tree-hierarchy of arbitrary depth and size in such a way that the rules of said Node Grammar are complied with at all times.

Accordingly, in a further broad form of the invention, there is provided a digitized application for implementing a fully web-enabled process for diagrammatically representing the meaningful structure of a complex argument or debate, or other similar information, as a schematic map made up of nodes each of which represent a discrete element in said meaningful structure comprising the steps of:
a. Beginning a new map by specifying the broad subject matter and other data about said map and selecting from one of a plurality of sets of encoded information and rules, termed Node Grammars, that constrain how nodes of different types may be combined to form maps and the actions available to persons building or otherwise interacting with said maps.
b. Associating selected information extracted from said argument or debate, or other information, with said nodes.
c. Adding nodes to said schematic map in such a way as to form an overall structure in which information is organized as a tree-hierarchy of arbitrary depth and size in such a way that the rules of said Node Grammar are complied with at all times.

In yet a further broad form of the invention there is provided a system as claimed in any of the claims of this specification.

In yet a further broad form of the invention there is provided a memory mapping system wherein nodes linked into a tree structure are segregated into subgroups, each subgroup adapted to be loaded into memory independently of the rest of the tree structure.

Preferably said memory mapping system is utilized to implement the system described above.

Preferably said memory mapping system is utilized to implement the method described above.

In yet a further broad form of the invention there is provided a system for storing and processing information in a digitized form associated with a debate comprising:
a) a plurality of interconnected computers;
b) a server wherein said server is interconnected to each of said plurality of interconnected computers;
c) server memory associated with said server;
d) a plurality of nodes of information associated with said server memory;
whereby said plurality of nodes of information may be accessed by users of said plurality of interconnected computers according to a set of grammar rules.

Preferably said set of grammar rules which determine the capacity to edit and access information associated with each of said plurality of nodes of information is associated with the levels of credentialing assigned to each of said users.

Preferably altering and accessing information associated with each of said plurality nodes information substantially alters only the information associated with said plurality of nodes in said server memory so as to minimize the transmission of information in association with said system.

### BRIEF DESCRIPTION OF DRAWINGS

FIG. 1 is a schematic view of a web page used to begin a new map in accordance with a first preferred embodiment.

FIG. 2: Flowchart of stored procedure invoked when a map is initiated.

FIG. 3: Schematic view of the web page for viewing and interacting with maps.

FIG. 4: Schematic view of the main control panel on the page for viewing and editing maps showing control clusters.

FIG. 5: Map information cluster on the main control panel.

FIG. 6: Navigation control cluster on the main control panel.

FIG. 7: Drop-down list for initiating actions on the map viewing page, showing a typical set of editing actions.

FIG. 8: View of the cluster of controls for editing map nodes when the user is in the process of adding a new node.

FIG. 9: Schematic view of information display on the map viewing page when the user is in BROWSE mode.

FIG. 10: The mode selector control, used for selecting NORMAL, EDIT or BROWSE mode.

FIG. 11: Schematic of information and controls visible above the map display.

FIG. 12: Flowchart of procedure when a map is initially loaded into the map viewing and editing page.

FIG. 13: Schematic view of information displayed when user views long text of node in secondary panel area to the right of map display.

FIG. 14: Schematic view of settings sub-panel on map viewing and editing page used to select customize the map display in various ways.

FIG. 15: Schematic view of sub-panel used to evaluate nodes.

FIG. 16: Schematic view of sub-panel used to conduct full-text searches of nodes and resources.

FIG. 17: Schematic view of sub-panel for displaying information about the current map grammar and about users of the current map.

FIG. 18: Typical node display format showing context menu and tooltip.

FIG. 19: Layout and relationships between Aggregator, Warrant, Cross-Reference and Authorizer nodes.

FIG. 20: Flowchart of application logic when user repositions to a different node.

FIG. 21: Flowchart of application logic when user moves a node and its subtree from one map location to another.

FIG. 22: Schematic of web page for viewing sorted and filtered tables of web resources.

FIG. 23: Schematic of web page used for specifying subsets of text documents.

FIG. 24: Process followed by user to specify a new map grammar.

FIG. 25: Schematic view of application Help System control.

FIG. 26: Schematic of columnar stack treeview layout.

FIG. 27: Applying multiple grammars to the same node data.

FIG. 28: Showing document subsets in context or extracted from context.

FIG. 29 is a block diagram of a web environment to which a second embodiment of the invention is applied.

FIG. 30 is a diagram of memory structures applicable for use in conjunction with the environment of FIG. 29.

### DETAILED DESCRIPTION OF PREFERRED EMBODIMENTS

### First Preferred Embodiment

### 1. Introduction

In recent times, a number of software tools have been developed for the purpose of creating diagrammatic representations of arguments and debates in different spheres including legal, philosophical, historical or scientific controversies or ethical and public policy debates. These are generally referred to as ‘argument maps’ or ‘argument trees’. Such software tools have also been used to assist decision-making within organizations. Most such tools to date have been developed primarily for the desktop or closed network environment. Tools developed for the open network or internet environment have generally provided limited functionality.

This specification describes an invention (herein called DebateMapper). DebateMapper is a software tool that enables the collaborative building of argument maps and associated repositories of relevant information resources using a web browser interface. It is specifically attuned to modeling the structure of large, complex debates, in contrast to most existing tools which tend to focus on arguments of limited size and complexity. In the scholarly literature, the term ‘debate mapping’ is sometimes used to delineate the former type of modeling from smaller-scale argument mapping. DebateMapper has an overall architecture and a range of specific features designed to support this type of large-scale modeling by communities of users who interact with it using standard web browsers. Throughout this specification such structures are referred to simply as ‘maps’. In broad terms, the invention provides a software tool for argument/debate mapping that:
Allows the creation of unified repositories of large and small argument maps, each governed by a set of rules and constraints which determine how users may build, edit and otherwise interact with them (each set of such rules and constraints being herein termed a ‘map grammar’).
Provides for multiple expressions of each element in an argument structure, specifically: A ‘brief text’ that appears on the outline map node, a tooltip text that appears when the user moves the mouse over the node, a ‘verbose text’ that is rendered to the right of the map when the node is selected, and an ‘elaboration’—an expression of the argumentative point of unrestricted length (other than storage constraints). Users can readily add each of these items, and all can be readily displayed during map viewing sessions.
Provides a plurality of map grammars to suit different purposes and enables users to specify customized map grammars for particular application domains.
Enables users to build large repositories of information items available on the World Wide Web (WWW), including papers, articles, media items, queries or subsets or transformations of these, with such repositories being structured around argument or debate maps.
Provides complete functionality to users with nothing more than a web browser installed on their computers.
Enables communities of users to collaborate over the web in building, editing and evaluating the above-mentioned argument/debate maps and associated resource repositories.
Provides means for communities of users to collectively evaluate argumentative elements and maps and associated resources, and to filter, sort and customize the displaying of map and resource information in a variety of ways.
Includes facilities for marketing relevant items in conjunction with map nodes and resources.

### 2. Broad Application Architecture

A possible broad implementation architecture for the invention is described in this section. More detailed information about how specific novel features are implemented is included in later sections. The implementation described in this specification uses a three-tiered web application design consisting of data, middle-tier and presentation layers. It consists of the following main elements:
A relational database containing a set of tables that contain information for each map, for each element in any map (hereafter termed a ‘node’), for each resource or sub-resource associated with any map or node, information about all credentialed users of the application and their rights and permissions in relation to particular maps and the repository as a whole, user evaluations of nodes and resources, pre-installed and user-defined map grammars, and information about items offered for sale in conjunction with map nodes and resources. A set of constraints, relationships and indexes associated with the tables.
The relational database includes a set of programs, known in the software programming field as stored procedures and triggers, designed to efficiently retrieve information from the above-mentioned tables and update such information in response to user inputs and to ensure the integrity of data stored therein.
A software application, consisting of a collection of web pages and associated programming code hosted on one or more web servers that handle the presentation of information to users and enable user interactions.
A library of software components making up a middle-tier for the application that processes and prepares information retrieved from the relational database and passes it to the presentation tier, and updates or modifies information stored in the database or in the web server filing system in response to user actions or other processes.

One possible implementation of this architecture makes use of Microsoft's ASP.NET framework and consists of a set of interactive web pages each with programming code stored in separate files (‘code-behind’ pages, in Microsoft's parlance) for the presentation tier, a collection (‘library’) of software components for the middle tier, and a relational database served by Microsoft SQL Server (or other suitable database server) and accessed programmatically from the middle tier using Microsoft ADO.NET data access components, supplemented by the web server file system for storing certain kinds of information. The application uses some standard methods to maintain data integrity, such as foreign key relationships to ensure referential integrity and optimistic data concurrency checking. This architecture is compatible with a variety of physical deployment scenarios, depending on level of usage and other considerations. The application makes extensive use of the vast ASP.NET class library for purposes such as data access, working with XML documents, processing strings with regular expression classes, and so on. The ASP.NET validator controls are used for input validation.

One of the key problems for a web application of this type is that of ‘state management’, maintaining information about user interactions, the state of various controls, various key variables and data objects, and so on across repeated post-backs of pages to the web server. The DebateMapper application uses ASP.NET features to achieve this, such as the use of ‘ViewState’ to store the settings of page controls. It also makes extensive use of server-side caching in two forms: the application wide cache, which holds information accessible to all users of the application; and the ‘session’ object, which provides a user-specific memory accessible only by code executing within a particular user session. In general, the cache is used to store information that is the same for all users, while the session object is used to store information unique to each user such as the users unique identifier (primary key value in the Users table), login credentials, permission set, and information about the dataset the user is currently working with in a session). The session is also used to persist data items that indicate the ‘mode’ that the user session is in (for example whether the user is currently browsing a map, editing the map, or performing a specific editing action).

### 3. Description of Key Features

The following sections describes the distinctive and novel features of the DebateMapper application and how they are implemented within the broad architectural schema described above.

### 3.1 Map Node Data

All DebateMapper maps consist of a collection of discrete elements, which in most cases correspond to discrete elements in an argument structure which are combined to form a map. Throughout this specification these elements are termed ‘nodes’.

In a map created using the DebateMapper application, these are organized in accordance with a set of rules or constraints herein termed a ‘map grammar’. All map node data is stored in a single logical Nodes table (which for a large repository may be distributed over multiple database servers), with a unique table row containing a set of information for each node. This table is self-referential with each node (with one exception) having as part of its data a designated ‘parent’ node which sits above it in the tree hierarchy. The one exception is the root of the entire repository of map node data, termed throughout this specification the ‘repository node’. Each map has as its root a node, termed the MapDescription node, which is normally a direct child of the repository node. All nodes, with the afore-mentioned exception, must have exactly one parent node and may have an arbitrary number of child nodes. This structure makes possible repository-wide navigation and (subject to certain constraints) editing of map data. DebateMapper includes a number of features, described in later sections, which enable departure from this basic tree-hierarchic structure. The following data is stored for each node in the Nodes table:
A unique identifier, an integer which is the primary key of the Nodes table;
A brief text for the node, which appears on the node when the map is displayed;
A verbose text, a more detailed exposition of the semantic content (for example, the argumentative point) of the node. This is normally displayed on the right of the main map viewing and editing interface when the user selects the corresponding node by left-clicking it;
A succinct text which may be displayed in a tooltip when the user moves the mouse over the node;
The type, or class, of the node (see description of Map Grammars below);
Information indicating the node's position in a map structure: the unique identifier (primary key value) of its parent, and a Boolean flag indicating whether it has any children or not;
A set of metadata about the node: the author, the editing history of the node, when it was added, whether the author has chosen to ‘lock’ the node thereby preventing other users editing or deleting it;
The location (normally a Uniform Resource Locator or a database location) of any article added by the author to fully expand on the point expressed succinctly in the node texts;
The location of any XML transformation document that should be applied to filter or transform of any afore-mentioned article;
The number of afore-mentioned resources that have been associated with it by the node author or other users;
The average evaluation of the node by all users who have evaluated it by giving it a numerical score, and the number of users who have evaluated it.

The above data is entered and maintained by the DebateMapper application using stored procedures, triggers and SQL commands created and programmatically called by middle tier components as described below.

### 3.2 Method for Retrieving and Displaying Map Data

DebateMapper includes a set of database stored procedures written in Structured Query Language (SQL) for querying and updating of information in the above-mentioned Nodes table. In order to work with tree-hierarchic data of arbitrary depth, certain of these stored procedures employ the programming techniques of recursion and dynamic SQL, in which programming statements are built using string methods at run-time. The following DebateMapper stored procedures use this approach:
The stored procedure used to retrieve tree-hierarchic map node data to a specified depth.
When a user editing a map attempts to move a node and its subtree from one location to another by changing its parent, a stored procedure is used to ensure the node is not being moved to one of its descendants in the tree-hierarchy (which would isolate some node data from any map structure).
The stored procedure used to permanently remove node data from the database by recursing down to some specified depth. Note that the first stage in removing a node and its subtree is to move it, by changing its designated parent node, to a specific node in each map herein termed the ‘Deleted’ node (analogous to the Windows trash bin).

A large map may contain hundreds or even thousands of nodes, and a DebateMapper server(s) may have many maps, the entire repository of map data having the unified structure described above with the repository node serving as the root of the entire structure. DebateMapper has features which enable the user to work, at any time, with a small subset of this data, while easily navigating around the map and/or the entire repository of maps. The application interacts with the database by recursively retrieving a user-specified subset of node data defined by the starting point node (indicated by primary key value) and depth in the tree structure to which data is to be retrieved (e.g. five layers). This information is retrieved and cached in the web server memory and held there until updated or replaced with another set of retrieved data. While in the server memory, the data can be used by the presentation tier to populate map diagrams rendered to the user's web browser and to support user interactions with particular nodes. The data for a particular user is stored in a user-specific area of the server memory, in Microsoft's ASP.NET framework as one of the items stored in the ‘session object’ (alternatively, map data could be stored in the application-wide cache with only a lightweight set of data stored in the user session indicating the subset of cached data being worked with).

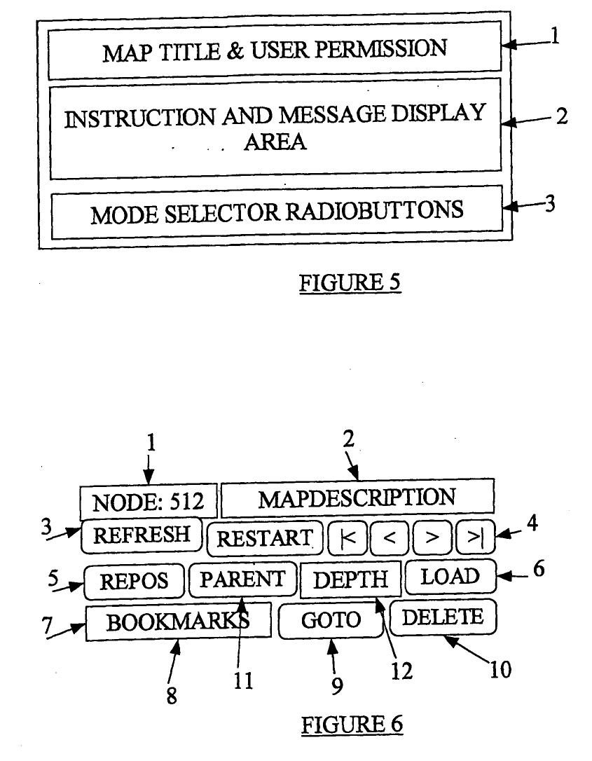

When a map is initially loaded by a user, a standard subset of node data for the map is retrieved and rendered, typically the MapDescription node and its immediate children, each of which may represent one of the main issues or debates to be addressed in the map (this also includes the Deleted node for the map, used as a temporary location for nodes marked for deletion from which they can be restored if necessary). The primary key value of the MapDescription node for each map is included in a separate Maps table, which contains a set of information about the map (described in a later section). Once this initial dataset is cached in the server memory and rendered, the user can opt to load an additional dataset by setting the depth control 12 (refer FIG. 6) and selecting a node which is to serve as the starting point for the additional retrieved data and clicking load button 6 (refer FIG. 6). In this way, the user can progressively add more data illuminating the areas of the overall map structure that are of interest. DebateMapper also allows the user to reposition on the map, clearing the existing cached dataset and loading a fresh dataset starting at a selected node to the depth indicated. DebateMapper also enables the user to jump to a specific location by going to a bookmarked or cross-referenced node, or to a node returned by a full-text search. The user can also retrace any navigation steps by clicking back/forward/beginning/end buttons on the web interface.

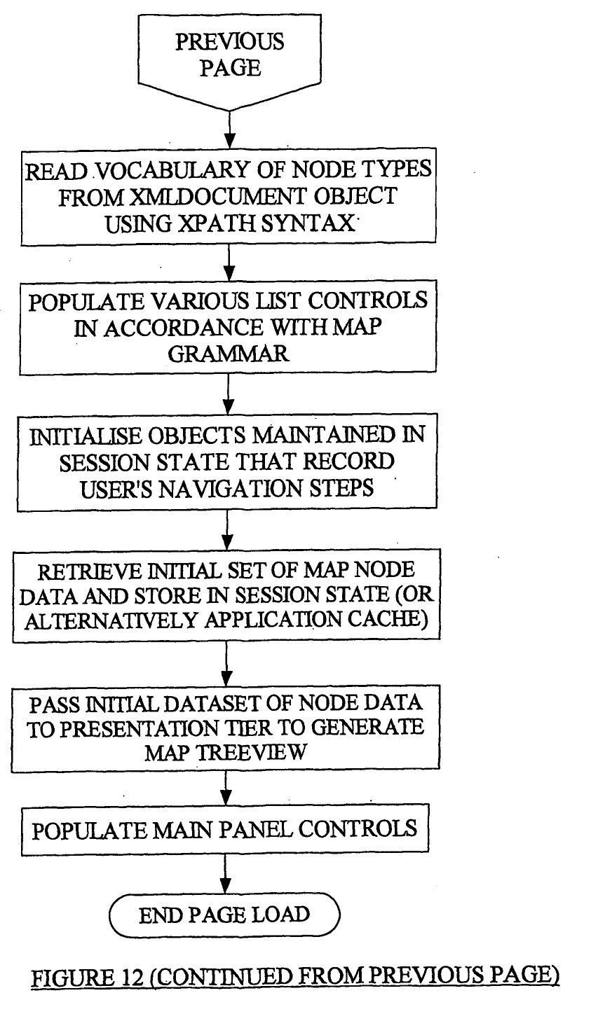

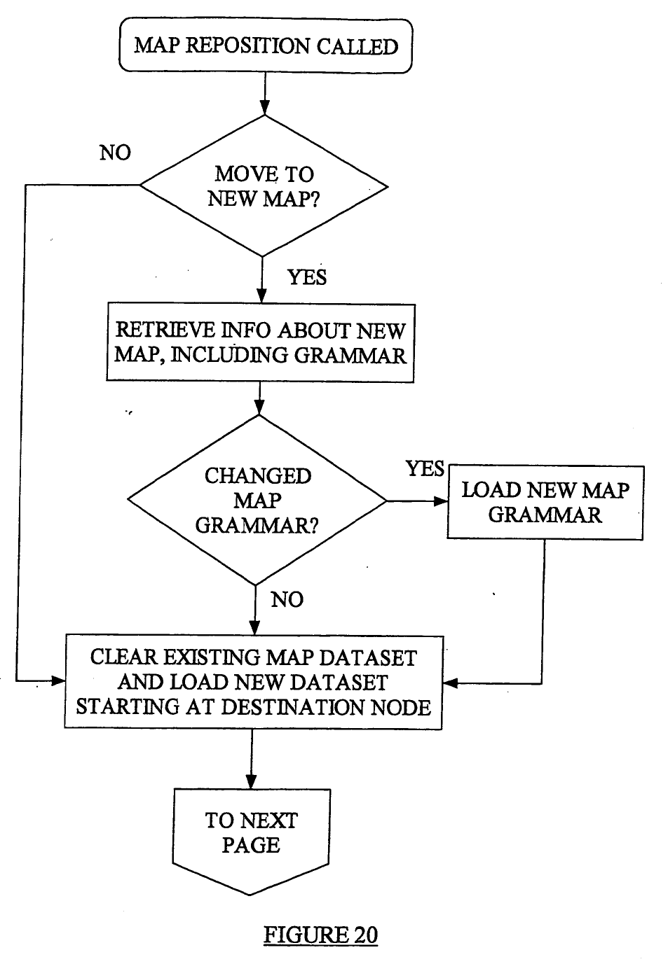

FIG. 12 provides a flowchart of the main processes that occur when a DebateMapper map is initially loaded (Note: the decision checking for a server callback is necessary because the proprietary Telerik treeview control used to display maps raises the page load event with IsPostback set to false when populating a treeview by server-side callback. In this case it is necessary to execute only the node-expand event handler code and to bypass the normal page-load code). The flowchart of FIG. 20 depicts the logic when the user repositions to a different node in the same map or a node in a different map—the latter can be achieved by going to a bookmark, or a cross-referenced location, or by going to a node returned by a full-text search of nodes).

DebateMapper also enables users to apply filtering criteria to the retrieved data, including:
Excluding specified classes (or types) of nodes;
Excluding nodes below some specified average weight or significance, as assessed by users (see section on map evaluation below);
Excluding a set of nodes designated to be excluded in accordance with some stated rational (for example, an assumption that renders certain lines of argument or argumentative points irrelevant). Users have the option of creating ‘selective views’ of any map by applying one or more such assumptions;
Exclude any nodes of the type herein termed ‘PrivateSpace’ which are designed to provide invisible working areas to map users as they build and edit map structure. Any PrivateSpace not owned by the current user is rendered invisible.

Filtering is implemented by providing drop down lists, listboxes and other web interface controls by which users can express their preferences. Such control settings are read programmatically and used to generate parameters which are passed to the stored procedure which retrieves node data. The program logic in the stored procedures customizes the retrieved data accordingly.

### 3.3 Map Grammar and Structure

A DebateMapper map is a set of node data, as described in the preceding section, together with what is herein termed a ‘map grammar’. Node data is organized into maps as a tree hierarchy, though DebateMapper includes several features (such as cross-referencing of map nodes and the subtree inclusion mechanism described in Section 3.4) that provide a means for modeling non-tree hierarchic data.

The Wikipedia internet encyclopedia contains a short article describing tree-structures (http://en.wikipedia.org/wiki/Tree_structure). See also Peter Eades, Tao Lin, and Xuemin Lin, ‘Two Tree Drawing Conventions’ (International Journal of Computational Geometry and Applications, 1993, volume 3, number 2, pp. 133-153). Trees are one of the standard data structures that recur in computer science, and are frequently used to represent information arranged in a hierarchical order (e.g. organization charts, computer filing systems, documents with a chapter/section/sub-section type structure etc). Each of the elements in a tree structure are usually referred to as nodes, and the terminology of family relationships is used to describe how they are related to each other in the map structure. A node directly above another in the hierarchy (i.e. one level closer to the root) is called the nodes' parent. Nodes that sit below another node in the hierarchy are called children (or child nodes) of that node. Nodes at the same level in a branch of the tree are called siblings. A node that is connected to all lower level nodes in a tree portion (or subtree) is termed an ancestor of these nodes, all of which are descendants of it. The XML web language provides a very suitable way of encoding such structures, and uses the same family-relationship terminology. XML is a central feature of the DebateMapper technical implementation.

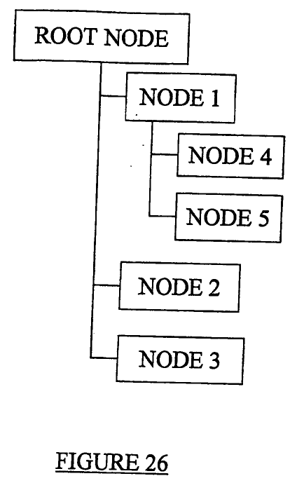

A tree structure can be presented in various ways, all of which are essentially the same (or as the mathematician's would say, topologically equivalent). The choice is purely a matter of convenience. The ‘inverted tree’ rendition often used for organization charts is one option. Others include a right-way-up tree, a left-to-right tree—the latter a common format for argument maps. DebateMapper uses a ‘columnar stack’ format in which the root is at top-left, the tree deepens (adds more levels) in a left-to-right direction and widens (adds more siblings) in a top-down direction. See FIG. 26 for a schematic view of this representational format.

A map grammar consists of:
A ‘vocabulary’ of node types, or classes, that may be included in a map adhering to a particular grammar. In the scholarly argument mapping literature, this is generally referred to as the map's ‘ontology’. Each node type has a distinct semantic and/or functional significance. For example, one type of node may be used to raise an issue for consideration in the context of a map of a debate, or to state a contention in response to the parent issue, or to express a point supportive of that of its parent, or opposed to it. Different map grammars express different viewpoints or theories about how structures of argumentation should be schematically laid out. Normally, each node type will have a unique CSS style class to distinguish it visually when rendered. Optionally, it may also have an accompanying graphic icon.
A set of rules that constrain how nodes of different types may be nested in the map's tree structure. Each node type has an allowable set of types as children.
A set of rules that constrain how users may edit or otherwise interact with the map. In this specification, actions are classed as ‘normal’ or ‘editing’. For each node type, there is a set of permitted normal actions and a set of permitted editing actions. Descriptions of the different kinds of user interactions are described in below.

In this implementation, the map grammar is encoded in two Extensible Markup Language (XML) documents: one for the vocabulary and one for the above-mentioned rule sets. Examples of such documents are included at attachment . . . . Both these documents must be valid against an XML-Schema specification. These documents are stored in the web server file system (alternatively, they could be stored in a database table). Information about each available map grammar is stored in a Grammars table in the database. When a user requests a map, the primary key of the grammar applying to the map in the Grammars table is retrieved from the Maps table. The two XML documents are then loaded into XML document objects held in the server memory. These cached XML document objects are queried programmatically (using methods of the .NET xmldocument class) during each user's session to ensure that interface controls on the ViewMap interface are set to only display those options permitted by the applicable map grammar at all times.

DebateMapper includes a method for beginning a new map by applying a different map grammar to the node data for an existing map. This type of map is termed a secondary map. A map with brand new data is termed a primary map. This provides a way to provide fine-grained control over how different classes of users can edit and interact by providing different editing and interaction rules in separate maps that reference the same map data. This feature is employed in the implementation of Comentator permission as described in section . . . below. Users with Commentator permission are given limited, rather than full editing rights of the data of a particular map by applying a grammar enforcing such limited rights (such as adding Comment or AlternativeWording nodes only).

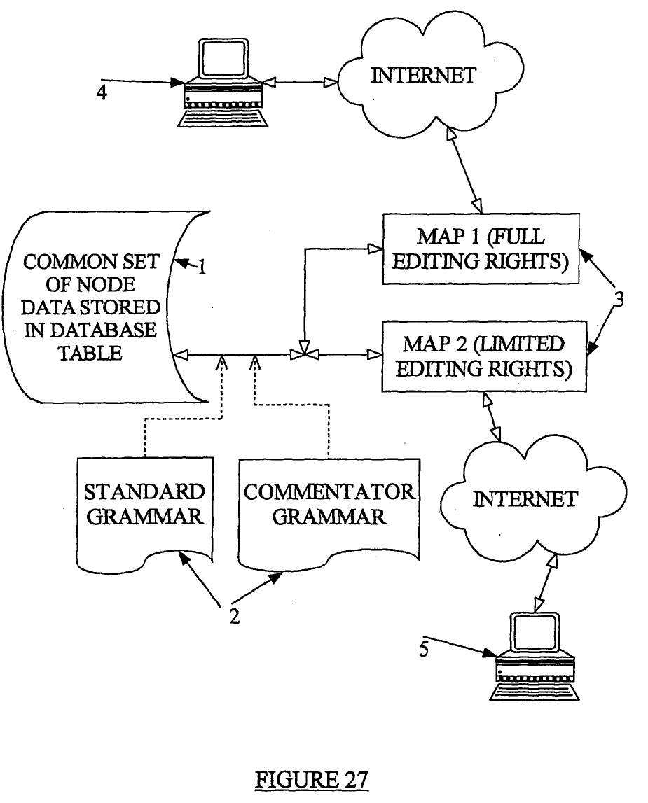

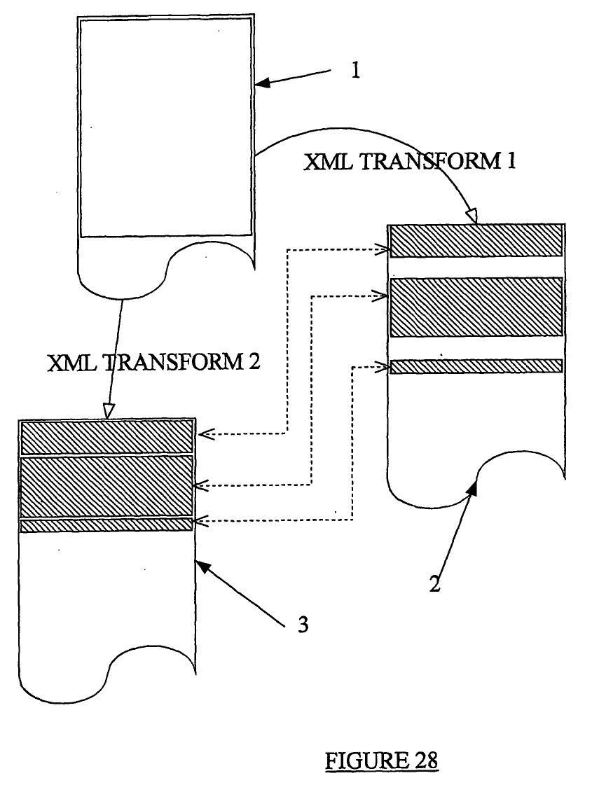

DebateMapper comes with a set of pre-installed map grammars reflecting some commonly used formats for argument layout. There is also a grammar specifically for the application Help system, which is stored as a map with a simple grammar to that users edit or annotate it using the ViewMap interface. Generic administrators can perform full editing, other users limited editing. These rights are specified in the respective grammars. FIGS. 27 and 28 show, as examples, listings of the XML files used to encode the rules and ontology respectively one of the pre-installed grammars.

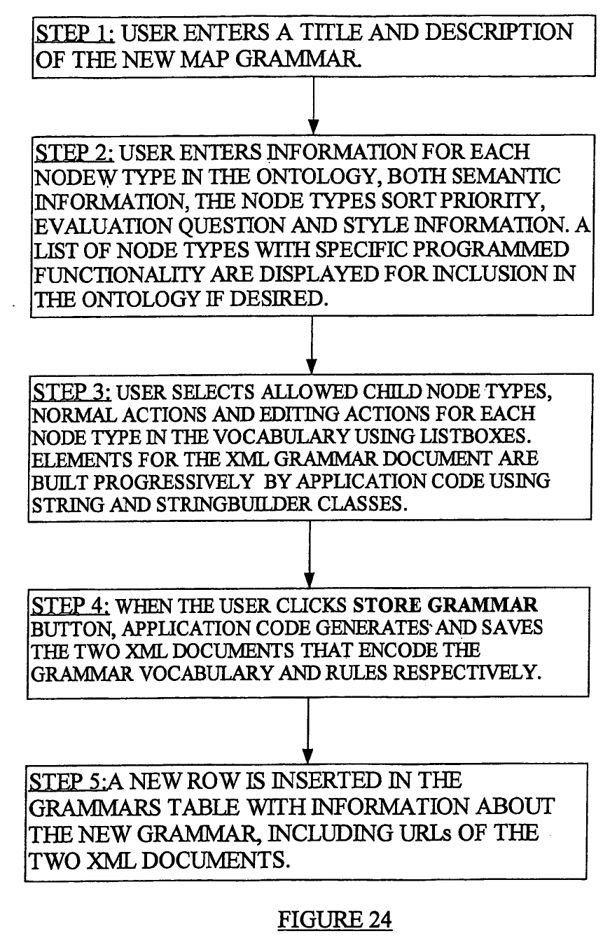

There is also an application web page that permits users to specify a custom grammar, with its own ontology of node types (including the DebateMapper types that provide specific functionality—such as CrossReference nodes and Warrant nodes (as described in Section 3.4 below). A schematic diagram showing how users would build a custom grammar using this page is shown in FIG. 24.

### 3.4 Special Node Types

As described above, DebateMapper permits a wide variety of map grammars to be specified. In specifying such grammars, by either hand coding the relevant XML documents or using the special user interface designed for this purpose, users have wide discretion to specify a vocabulary of node types that suit their application domains, having whatever semantic significance they see fit. The only constraint is that each node must have as its root a MapDescription node, which is used to describe the broad subject matter of the map, and a Deleted node, which serves as a temporary storage location for nodes marked for deletion by map editors.

There are, however, a number of special node types that provide specific functionality when included in a DebateMapper map. The application logic treats them in special ways. DebateMapper supports the following such node types:
CrossReference nodes can be added as children to nodes of other types to provide a way of cross-referencing other locations in the some map, or another map in the repository. There is a specific editing action (described below) to add a cross-reference to the currently selected node, which adds a CrossReference node with a user specified brief text, and a verbose text which includes the unique identifier of the cross-referenced node. If the user selects such a node and the application is in NORMAL or BROWSE mode, the user has two options. If the user clicks the reposition button 5 of FIG. 6, the application code retrieves a fresh set of data starting at the cross-referenced node to the depth specified on the depth drop-down list 6 of FIG. 6. If the user clicks the load button 6 of FIG. 6, the same fresh dataset is retrieved, but is rendered in situ, at the position in the map occupied by the CrossReference node. The latter method is termed ‘subtree inclusion’ in this specification. CrossReference nodes are handled differently when they are added to Warrant nodes—this is described in the section on Authorizer nodes below.
PrivateSpace nodes provide users with a means to add private annotations or draft map structures without these being exposed to view by other users. When the stored procedure to retrieve node data is called by application logic, the string parameter that specifies how the retrieved data is to be filtered precludes retrieval of any PrivateSpace nodes (and hence their subtrees, since the retrieval method recurses down the tree structure) other than those added by the user in the current session. When a user is satisfied with a draft structure, it can be moved to the visible part of the map and the PrivateSpace node deleted.
Warrant nodes are designed to support argument layouts that require that each argumentative inference have a rationale, license or warrant. This is the approach favored by Stephen Toulmin, one of the founders of argument mapping theory (Stephen E. Toulmin The Uses of Argument Cambridge University Press 1958, 2003). In the application logic, Warrant nodes work in conjunction with the two following node types: Aggregators and Authorizers.
Aggregator nodes are also intended to support argument layouts that follow the Toulmin schema. An Aggregator node indicates the strength with which an argument, or a combination of arguments, supports a conclusion expressed by the Aggregator node's parent (it occupies the place in an argument layout occupied by the ‘modal qualifier’ in the Toulmin schema). If a map applying a Toulmin-type map grammar is set to require strict compliance (by user selecting a checkbox), any argument structure in which an Aggregator does not have at least one Warrant child is excluded from view when the application session is rendered in NORMAL mode. Aggregator nodes are rendered so as to visually indicate the strength with which the parent conclusion is supported. The Aggregator is rendered as a variable length arrowhead, in the current implementation between one and five ‘<’ characters indicating a range of weak to strong inference. The arrow's tail is also of variable length, and indicates the proportion of credentialed users of the map who have participated in the evaluation. In the current implementation, it is made up of from one to five hyphen symbols, indicating low to high proportion of credentialed users. Application logic generates the Aggregator arrow by looking up the average valuation of the node in the corresponding datarow and adding the required number of ‘<’ characters and by looking up the number of evaluators of the Aggregator from the datarow and computing the proportion of all map users. Unlike other nodes that can be evaluated, Aggregators may have positive or negative values indicating support or opposition respectively to the parent. A supportive Aggregator is rendered green, an opposing Aggregator red.
Authorizer nodes also support the Toulmin schema, which requires that all warrants have ‘backing’, some supportive authority. DebateMapper provides two methods to indicate such backing: Firstly, supportive argument structures can be added in situ, as children of the Warrant (this is consistent with the view of some argumentation theorists who hold that a Warrant is just like any claim advanced in the course of an argument). The second method is to cross-reference some node in the same or a different map which states a claim that is either identical with, or which strongly supports, the Warrant. This node may itself have an extensive argument sub-structure. The method to do this is to add a CrossReference to the Warrant node. When such a CrossReference is added, an Authorizer child is automatically added to the cross-referenced node, which specifies the Warrant the node authorizes. If a user creates a ‘selective view’ of the map (as described in Section 3.8.1) which excludes the node thus cross-referenced, any Warrant nodes authorized by any of its Authorizer children are also excluded, as are any map structures that as a consequence have no remaining valid warrant (if the strict option has been set).
AlternativeWording nodes allow a user with Commentator permission or higher to propose an alternative wording of the node texts of its parent node. An administrator may ‘promote’ the proposed alternative, as described in Section 3.8.2.

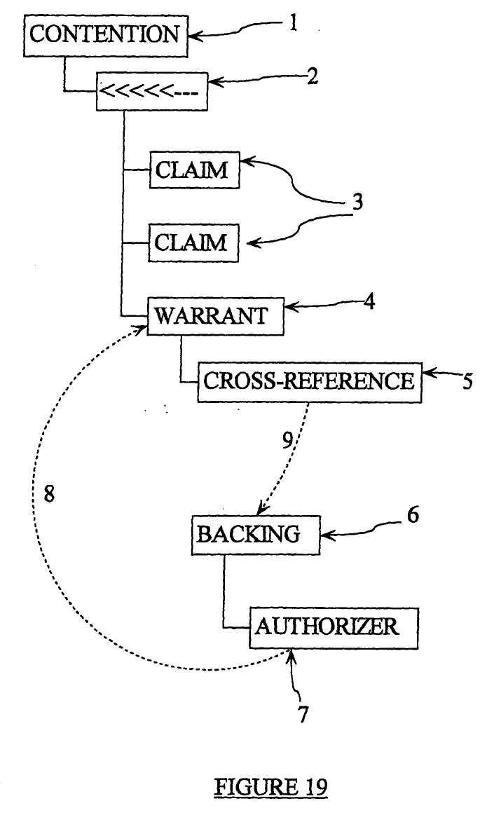

FIG. 19 is a schematic diagram depicting the relations between Aggegator, Warrant and Authorized nodes as described above. The dotted lines 8 and 9 signify that the relationships might apply to distant nodes in the same map, or in a different map.

### 3.5 Map Rendition

The presentation tier utilizes web treeview controls to display maps. The current implementation builds the required treeview controls programmatically from the cached node data table (held in individual user sessions or the application cache) using a recursive procedure to ensure that nodes are nested properly to the appropriate depth. A number of available proprietary treeview web control products are available that provide the functionality to display and interact with maps required by DebateMapper. These controls do not merely display the map data—they have a rich ‘object model’ of events, properties and methods that can be programmed against and which support the user interactions described below. This implementation utilizes one such proprietary control.

The following properties are set for each node as the treeview is built:
The text that appears directly on the node;
The text of any tooltip which appears as the user moves the mouse over the node. This can be used to provide a succinct expression of the node's semantic content, or a formatted set of metadata about the node, or other information;
The CSS style class that governs the appearance of the node when rendered. Each node type in the map's ontology has a distinct style class.

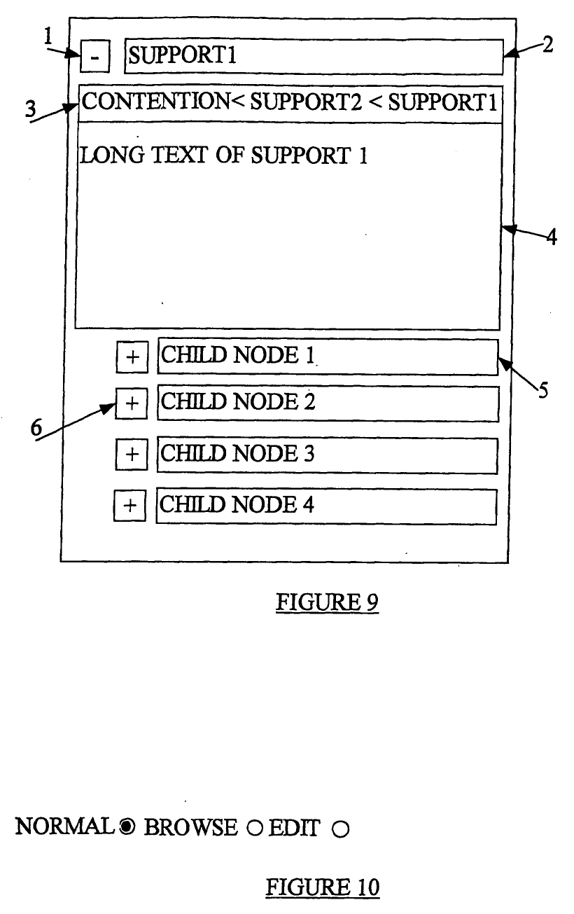

The data row (retrieved from the Nodes table) associated with each node contains considerably more information about the node than is displayed using the treeview. This additional information is accessed and utilized as described below. DebateMapper provides two format options for displaying map information:
An outline format in which, for each node, the node brief text is displayed together with symbols indicating whether the author has added a detailed elaboration of the node in a separate article or has associated any other resources with it; a symbol is also appended to the node's text indicating if the node has any child nodes that have not yet been retrieved from the database. In this mode, herein referred to as NORMAL mode, additional information, including the full expression of the node's semantic content and metadata about the node, can be accessed by selecting the node by left-clicking it with the mouse.
A format in which the map is initially shown fully collapsed, indicated by a visible ‘+’ sign to its left. Clicking the ‘+’ sign causes programming code to insert the full (verbose) text of the node inline below the brief text with a header indicating the node's position in the map structure, and then to add any child nodes below the expanded node's verbose text. The header 3 of FIG. 9 shows each step in the flow of inference from the expanded node up the tree through various stages of argumentation to the conclusion. Each arrow-separated segment of the header shows a move up the tree, and is rendered with the style attribute of the relevant node type, with tooltip texts for each step shown on mouse-over. The user can then progressively expand the parts of the map of interest by expanding the relevant node. In this mode, termed BROWSE mode, use is made of server-side callbacks (rather than post-backs of the whole page) for very rapid loading of data. By browsing the map in this way, the user can build a display document with a great deal of detailed map information. A schematic of the BROWSE mode format is provided in FIG. 9.

### 3.6 Method to Begin a New Map

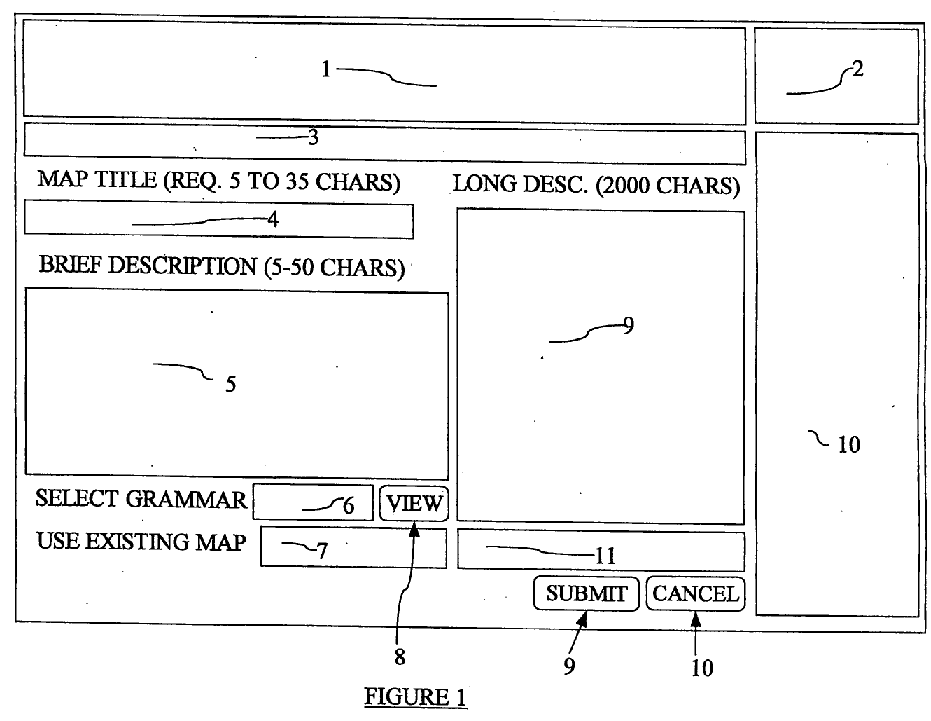

Any user with relevant permission (see section on the permission system below) can begin a new map. After logging on the DebateMapper entry page, the user selects the begin new map item on a drop down list and clicks a button to transfer to the web page for beginning new maps (termed the NewMap page in this specification). A schematic view of the NewMap page is provided in FIG. 1. On this page, the user enters a title for the map (texbox 4), and a brief and verbose text for the MapDescription node of the new map (in textboxes 5 and 9 respectively). The user must select a map grammar using drop-down list 6 that shows all the currently available grammars. The user can view details about the selected grammar by clicking View button 8. The user can then use check-boxes 10 to make the map private (visible only to those with explicit permission to access it), to enable the evaluation of map nodes and associated resources by the user community, and to enable ‘shopping’ for the map (see section below on marketing items in conjunction with map nodes and resources).

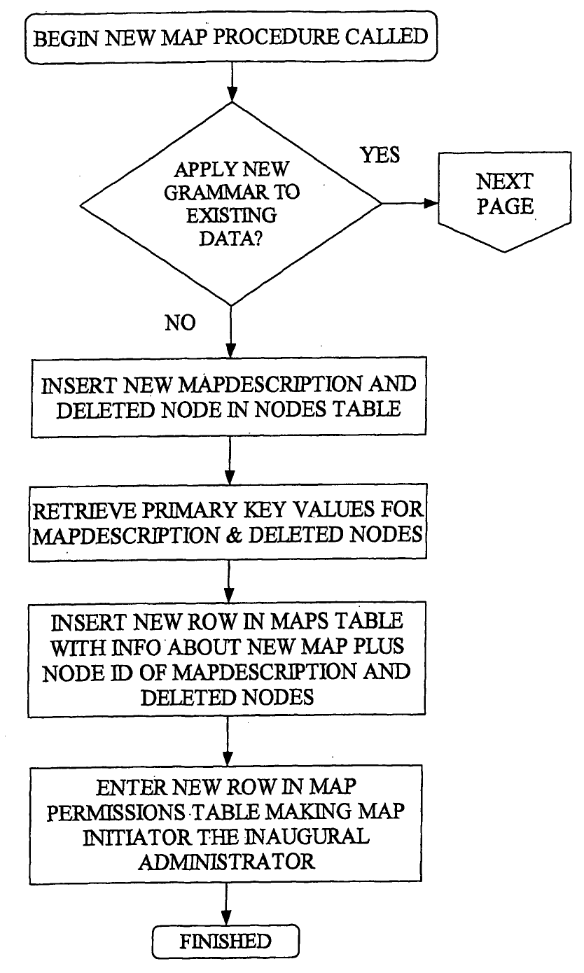

When the above steps are completed, the user clicks Submit button 9, which calls a database stored procedure which enters the new map in the database. This involves entering new rows in the Nodes table corresponding to the new map's MapDescription and Deleted nodes, and a new row in the Maps table providing information about the map, including the primary key values of the afore-mentioned pair of nodes that comprise the skeleton map. The map initiator is automatically made administrator of the new map, and the database Permissions table updated accordingly. The user is notified if this process has proceeded properly and upon returning to the DebateMapper entry page the new map should be visible on the drop-down list of available maps. The user also has the option of creating a new map by applying a different map grammar to the same set of node data. FIG. 2 provides a flowchart illustrating the main processes followed by application logic (in middle and data tier code) to initialize a new map. When a new map is created in this way, it appears on the drop-down list of available maps on the login page. Users with editing permission can now begin adding content to the two-node skeleton map consisting of the MapDescription and Deleted nodes thus created. It is up to the map's initiator (automatically granted Administrator permission for the new map), or a user with repository-wide administration permission, to begin assigning permission to other users to build and edit the map.

The user can also begin a new map by applying a new map grammar to the node data of a pre-existing map. This is called a secondary map. Drop-down list 7 of FIG. 1 is populated with a list of all existing maps for which the user has administrator privilege—this is required since the new map will be referencing the same node data as the existing maps. If an item on drop-down list 7 is selected, a secondary map is created accordingly.

### 3.7 The Main Map Viewing and Editing (ViewMap) Page

DebateMapper provides an integrated interface for building, editing, navigating and viewing maps. This is an interactive web page, herein termed the ViewMap page, implemented as an ASP.NET web form (like the other active web pages in this application). It consists of a multitude of web controls and static HTML elements grouped into a number sub-panels. Panels are a particular type of ASP.NET web control that can serve as the container for other controls. They can be overlaid on top of one another, with the visibility of each panel (and therefore of each control and HTML elements it contains) able to be set programmatically. This feature is used extensively in the ViewMap interface to pack a great deal of functionality onto the one web page, with only the needed panels and controls set to visible at any point in a user session.

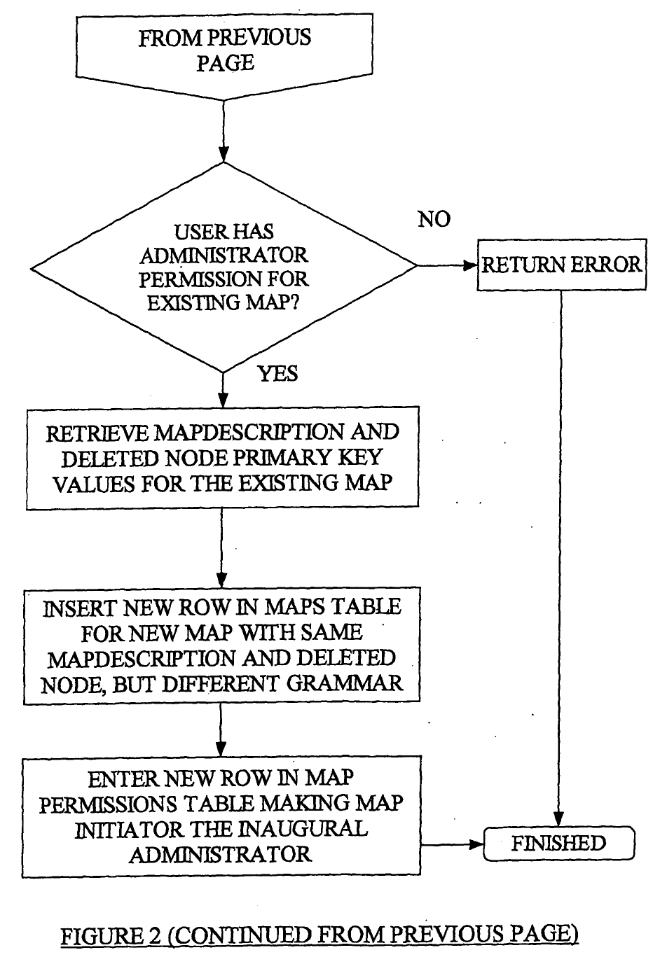

FIG. 3 provides a schematic view of the entire ViewMap page showing each of the main areas. The page is grouped into four main areas:

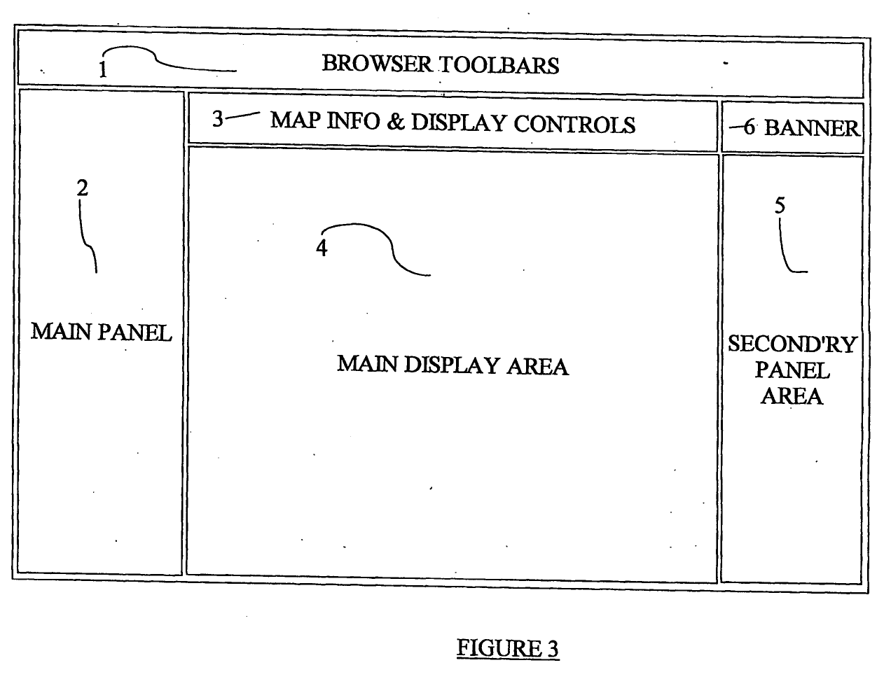

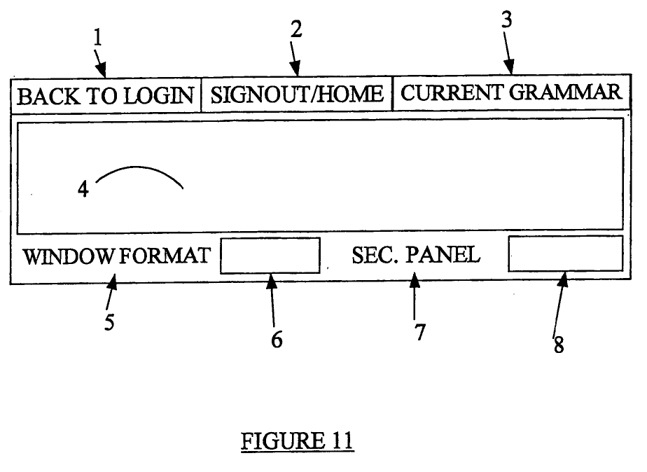

The Main Panel 2 of FIG. 3 on the left of the screen contains several clusters of controls that facilitate user interactions with maps. FIG. 4 provides a schematic view of the main panel, showing a number of related clusters of controls. The Info and messages cluster 1, at the top of the panel, shows information about the current map (the map name, the user's permission for it, and well as a message panel to display dynamically-generated instructions, error messages and other information to the user. Below the information cluster is the mode selector (2 of FIG. 4, also FIG. 10), a radio-button list control used to set the application session into either NORMAL, BROWSE or EDIT mode. The navigation cluster (3 of FIG. 4, detail in FIG. 6) displays the currently selected node's unique identifying number and the node's type. It also contains a set of buttons that allow the user to navigate around large maps by loading and displaying map data retrieved from the database and formatted as a map to the depth desired—this can be done repeatedly, selecting the appropriate starting point node for each load and then sitting depth control 12 to the tree depth required and then clicking load button 6, thereby populating the displayed portion of the map with the required information. The navigation cluster contains controls to do the following:
Reposition to the node that is currently selected (by left-clicking it) by clicking reposition button 5 of FIG. 6. This clears the map and the corresponding cached data table and loads and displays in map format a fresh set of data starting at the selected node to the depth specified by Depth drop-down list 12 of FIG. 6.
Reposition the map to the current node's parent node by clicking Parent button 11.
Restart the session by restoring the map to the state when initially loaded by clicking Restart button 3 of FIG. 6.
Select a bookmark using Bookmarks drop-down list 8 and clicking GoTo button 9 to reload the map from the bookmarked node. Click Delete button 10 to remove the currently selected bookmark.
Click Refresh button 3 to re-populate the currently displayed map dataset from the database.
Retrace navigation steps using stepping buttons 4. Suppose a user has loaded some map data, selected a node, repositioned to it (thereby clearing the original data and loading a fresh set starting at the node), selected another node, and then jumped to a cross-referenced location in a different map. The user can use these controls to move back and forth along these steps, displaying the correct map view at each stage. The information enabling this to occur is maintained in several session objects.

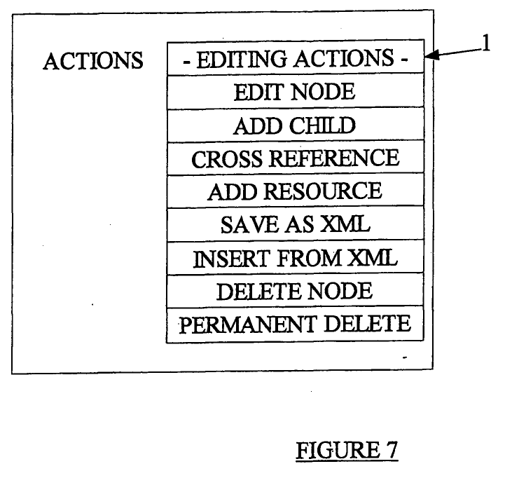

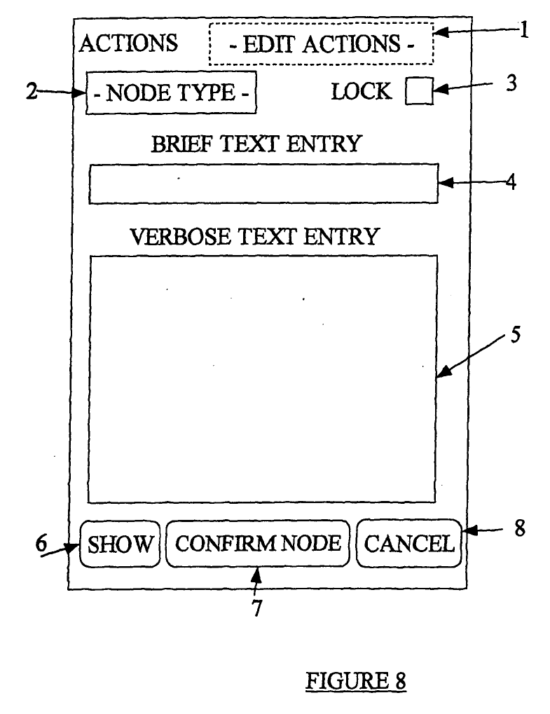

Action cluster 4 of FIG. 4 takes up the bottom half of the main panel and supports user interactions that act on the map data and related data and documents in a variety of ways. The appearance of this cluster, and the action of controls on it, depends on the particular editing or other action being undertaken. FIG. 8 shows the action cluster when the user is in the process of adding a new node to the map as a child of the currently selected node. The Actions drop-down list 1 of FIG. 7, and 1 of FIG. 8 (the button is here shown disabled since an editing action is already underway) contains actions currently available to the user. The list is populated with either ‘normal’ actions or ‘editing’ actions depending if the user is in NORMAL or EDIT mode. The particular set of actions is determined by the type of the selected node, and the current map grammar. The controls are disabled if the user is in BROWSE mode.

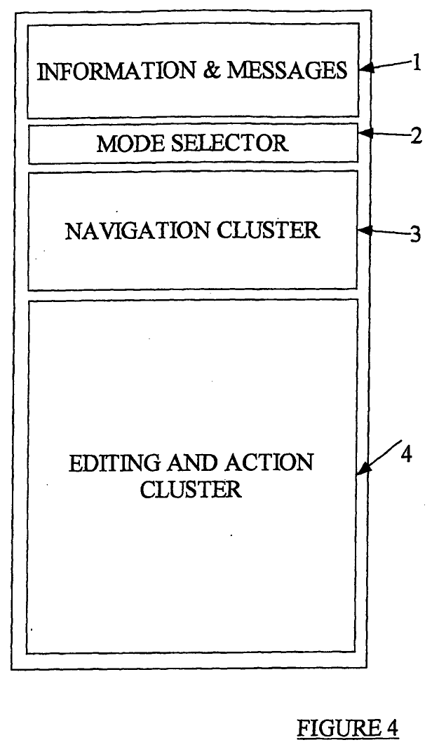

Textboxes 4 and 5 of FIG. 8 allow the user to enter or edit brief and verbose node texts respectively, or other information depending on the action being undertaken. For example, if the user is adding a bookmark, textbox 4 is used to enter the bookmark label (textbox 5 is disabled). If the user is storing a ‘selective view’ of map data, the title and description are entered in the two boxes. If the user is saving part of a map as an XML document, or importing map data from an XML file, textbox 4 is used to enter the filename under which the document is stored or the URL of the imported file respectively. Confirm button 7 is used to confirm actions (the text displayed on it varies depending on the action). Cancel button 8 is used to cancel the current action. Show button 6 is visible as users add new nodes or edit the texts of existing nodes to allow users to see how the text looks (including any HTML tags they have inserted) and to see how long the text is (there is currently a 1500 character limit for verbose text) without attempting to enter the information in the database. When the confirm button is clicked, certain further checks are performed to ensure the integrity of the data, including checking that it is a well-formed XML fragment and that there is no malicious code, and data is checked for optimistic currency. An error message displayed to the user in message panel 2 of FIG. 5 if an exception is raised, with a detailed report (including exception messages) displayed in secondary panel area 5 of FIG. 3.

The controls and settings of the main panel are populated according to the following factors:
The mode the application is in (NORMAL, BROWSE or EDIT as discussed above—there are also a number of sub-modes of EDIT mode). The mode value is a string value maintained in the user session. If in EDIT mode Actions drop-down list 1 of FIG. 7 list is populated with editing actions, as shown in the example drop-down list depicted in FIG. 7. In NORMAL mode a different set of (normal) actions are available.
The currently selected node type. Each grammar prescribes a set of available normal and editing actions when a node of each type is selected.
The current user's permission. For example a user with Administrator permission will be presented with actions available to administrators only, including such administrator-only actions as permanently deleting a node, and transferring to the Administration web page.

The main panel is repopulated in response to any user interactions that require it to be changed, such as the user selecting a different node, or the user selecting a different application mode. State information required for this purpose (including the type and other information about the currently selected node) is retrieved from session state or the application cache (the latter for information that is the same for all users). The actions available to users under the grammar being applied to the current map are programmatically read (using methods of the .NET System.Xml classes) from the relevant grammar XML documents. The application programmatically uses this information, together with page control settings, to populate the control panel appropriately.

The central part of ViewMap page of FIG. 3 is termed the Display Panel (4 of FIG. 3), and is the area where maps are rendered. If the user is in NORMAL mode, maps are displayed in an outline format with only the a short text visible on each map node made up of the brief text from the Nodes table concatenated with symbols indicating the availability of an elaboration on the text or other resources and whether there is un-retrieved data below the node. If in BROWSE mode, the user is presented with a completely collapsed treeview which can be progressively expanded to show each expanded node's verbose text (read from the corresponding row of the Nodes table) inline, together with any children of the node just expanded. When the user session is in BROWSE mode, DebateMapper uses a server callback mechanism for fast retrieval and population of the map without requiring a post-back of the entire ViewMap page (the tradeoff for this fast retrieval is limited functionality, with only the node expand event available). FIG. 9 provides a schematic view of the display area when the user session is in BROWSE mode. If the user is in EDIT mode, the map is displayed in the same format as NORMAL mode. A schematic diagram of the display area

When a map is displayed in NORMAL mode, the user may view a context menu for any node by right-clicking it (the proprietary treeview used for map rendition provides a means of specifying context menus using XML files). In DebateMapper, these menus give users the option to view any detailed elaboration on the node's semantic content which can be stored either in the database or as a document in the web server's filing system. The user is also presented with the option of viewing all the resources for the node using a special web interface (herein termed the DisplayResource page) which is described in a later section.

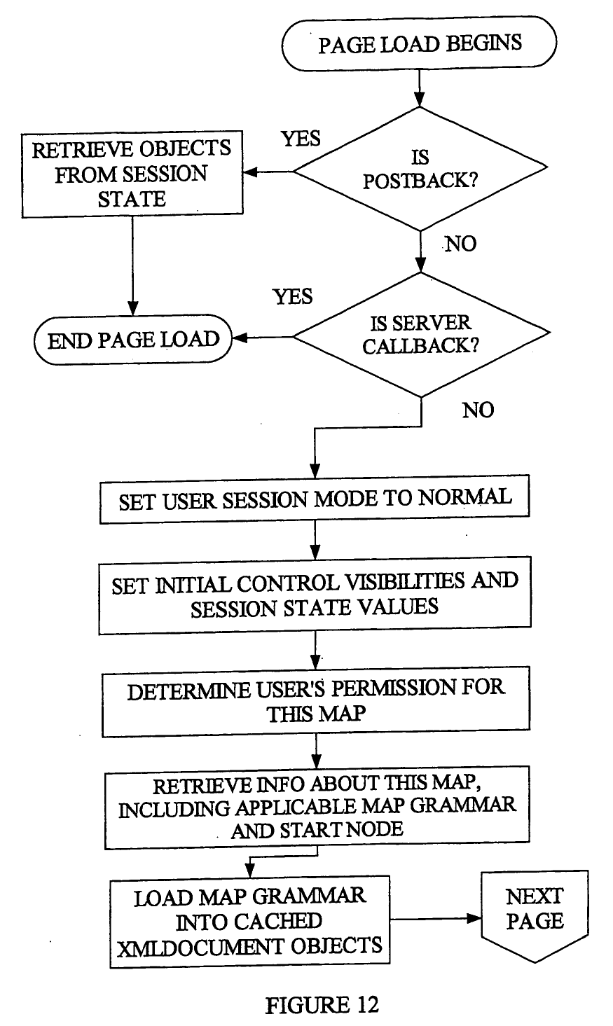

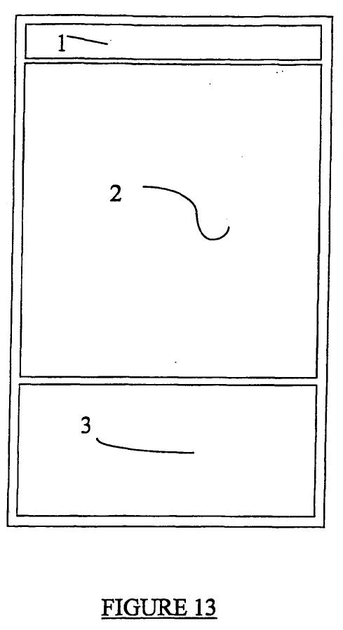

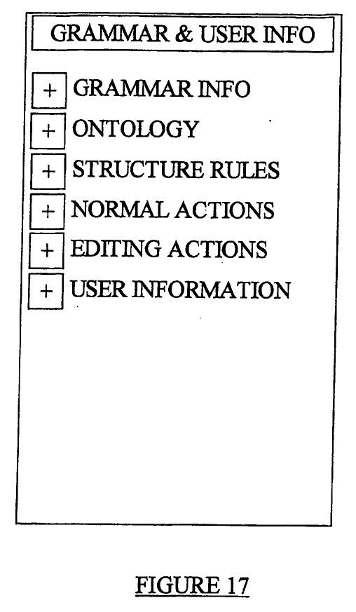

On the right of the ViewMap page of FIG. 3 display is the secondary panel area 5. This area contains an overlaid set of six sub-panels and information items, only one of which is rendered visible at any time. Users select the panel to show using secondary panel drop-down list 8 of FIG. 11 which appears above the main display area. Making a selection on the secondary panel drop-down list causes programming code to execute which sets the relevant item to visible and populates it with information as appropriate. The eight options are:
1. The verbose text of the currently selected node. When this option is selected, the primary key of the datarow in the Nodes table for the node currently selected is retrieved using the treeview selection event and then the datarow is (stored in server memory in either the session or cache objects) is queried for the verbose text, type, as well as a set of metadata. The verbose text is displayed (with any embedded HTML formatting applied) together with a formatted panel of metadata and other information about the node (including evaluation data). The schematic layout of the secondary panel when the verbose text is shown is depicted in FIG. 13. The display consists the following:
   Header 1, which shows the brief text in the corresponding data row and the number of characters in the verbose text
   The verbose text 2 for the node, with any HTML formatting (e.g. bold, ordered and unordered lists etc) applied.
   A metadata panel 3 derived from information contained in the node data row, including the node author and editing history, information about associated resources and user evaluations.
2. The information panel displays information about the map grammar applied to the current map and users of the map. The schematic layout of the information panel is depicted in FIG. 17. The following information about the map grammar can be viewed in this area:
   Basic information about the grammar including the title, description, who added it and date added.
   The ontology of node types in the grammar.
   The structure rules for the grammar. These govern how nodes can be combined into maps.
   The normal and edit action rules, which govern how people may interact with maps.

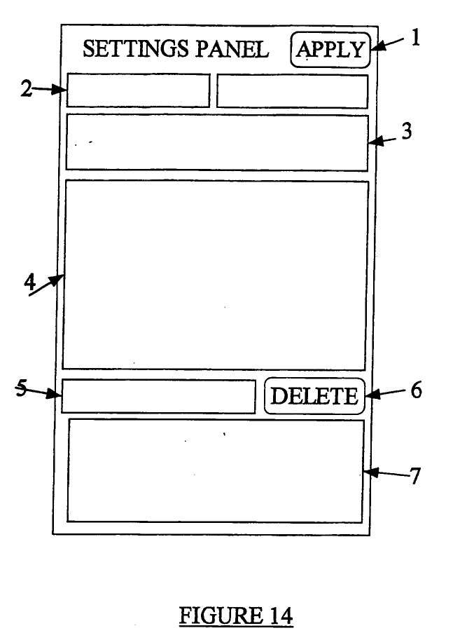

This information is programmatically read from the cached grammar documents to populate this panel. Detailed information can be displayed by clicking the ‘+’ signs alongside each item. User information is retrieved using a joined query of the Users and Permissions tables to retrieve users of the current map.
3. The settings panel depicted schematically in FIG. 14 enables the user to customize the viewing of maps in various ways by setting various drop down lists, listboxes, checkboxes and other controls. The user can customize in the following ways:
   By excluding from view nodes below some specified level of evaluated numerical significance, or weight, as assessed by the user community by selecting from Filter below drop-down list 2. It would be a straightforward matter to alter permit users to filter by other criteria such as the date the node was added, or by author.
   By selecting from several options for how nodes having the same parent are ordered by using the node order drop-down list (number omitted from diagram—fix) in different ways. The current default setting is to order them by node type, then by average weight.
   By excluding one or more specified types of nodes from view using listbox 3. Multiple node types can be excluded by holding down the Ctrl button while selecting.
   By choosing a ‘selective view’ (described below) which excludes parts of the map from view in accordance with some stated rationale. Available views can be selected using listbox 5, with a description of each appearing in information label 7 as each selection is made. The selected view can be deleted by clicking button 6, which is only visible if the user added the view or is an administrator.
   The user can set additional options using checkboxes 3. This includes the information displayed in tooltips that appear as the user moves the mouse over a node—the current options are to display an explicitly set tooltip text stored in the nodes table, or a formatted panel of metadata information about the node. The user can also set whether the bookmarks table on the main panel contains only bookmarks for the current map or all the user's bookmarks for the entire repository; and whether to enable special highlighting and formatting options (described below).

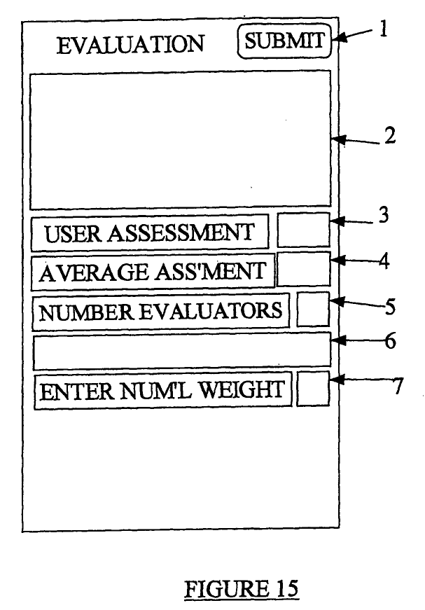

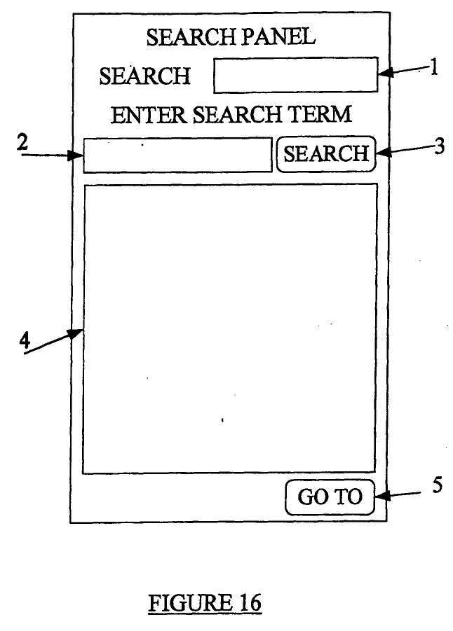

When the user clicks Apply settings button 1 at the top of the panel, the controls on the panel are programmatically read and application logic refreshes the data after generating a revised set of parameters that are passed to the database stored procedure which retrieves the node data, and the map is re-rendered with the new data and applying the new criteria.
4. The evaluation panel, depicted schematically in FIG. 15, enables users with the requisite permission to numerically evaluate the weight or significance of a node. For each node type, the map grammar specifies whether it can be evaluated (evaluation may be meaningless for some node types) and, if so, specifies an evaluation question which is displayed in message panel 2 as appropriate depending on the selected node when the panel is displayed. Node evaluation may be enabled or disenabled for the entire map by administrators. Users may use drop-down list 6 to choose from an enumeration of descriptors (e.g. very high, high, low etc) or may directly enter a numerical value within a specified range into textbox 7. As well as the evaluation question, the evaluation of the node by all users, and by the current user (if applicable) are displayed in message panels 3, 4 and 5. User evaluations are entered in a separate database table, one row per evaluation. Application logic encoded in a database stored procedure ensures that each user may have at most one current evaluation of any node. If a user re-evaluates a node, the evaluation data row is updated rather than a new data row being inserted. The Nodes table in the database contains columns for the current average evaluation value of the node by all users, and the number of users who have evaluated the node. These values are maintained by application logic encoded in database triggers that execute any time evaluation information is changed.
5. The search panel, depicted schematically in FIG. 16, enables the user to conduct full text searches of node and resource data. The user enters search terms, or Boolean queries, into textbox 2 and clicks button 3. Application logic builds a database query according to the entered terms or expression and queries columns in the Nodes or Resources tables that have been enabled for full-text searching. The result set is displayed on list-box 4. Users may specify using radio-button list 1 whether they wish to search specified columns of the Nodes or of the Resources table. After the search has concluded the user can go to one of the returned Nodes or Resources by selecting it and clicking button 5. In the former case, the map is reloaded starting at the retrieved node. In the latter case, the user is transferred to a separate page for viewing resources where are range of viewing options are available. After viewing such resource information, the user may return to the ViewMap page with the map loaded starting at the node with which the found resource is associated.
6. The application Help System can also be displayed in the secondary panel area. The Help System is implemented as an ASP.NET user control, and is described in section 3.12.

Finally, the user may opt to hide the secondary panel altogether, appropriate when a map is being displayed in large format.

### 3.8 Supported User Interactions on the ViewMap Page

This section provides further descriptions of how users may work with the application using features of the main viewing and editing (ViewMap) web page, focusing on the Actions drop-down list (item 1, FIG. 7) which appears on the Main Panel (see FIG. 7) (the action of the controls in the navigation cluster and the secondary panel have already been described in earlier sections).

The Actions drop-down list is, at all stages during a viewing or editing session, populated with a permissible set of actions. The available set is determined by the map grammar, the type of the currently selected node, the mode the user session is in (whether NORMAL or EDIT—this control is disabled when the user session is in BROWSE mode). The session object is used to persist information about which mode or sub-mode the user session is in at any time. This section describes the effect of each of the possible actions. Actions that can be selected using the Actions drop-down list fall into two classes: normal actions and editing actions, corresponding to whether the user session is in NORMAL or EDIT mode respectively.

### 3.8.1 Normal Actions

A number of actions can be selected from the Actions drop-down list when the user session is in NORMAL mode. These are each described below.
The user may bookmark the currently selected node. To do this, the user selects AddBookmark list item on the drop-down list. The user is prompted to enter a title in the text box on the main panel normally used to display the brief text. The confirmation button 7 of FIG. 8 is visible with text ‘Enter bookmark’. When this is clicked, the application code enters the new bookmark in the Bookmarks table in the database. When a map is loaded, all the bookmarks entered by the current user are retrieved and used to populate Bookmarks drop-down list 8 on the navigation cluster (see FIG. 6) on the main panel.
DebateMapper allows users to create and store for future viewing ‘selective views’ that filter out parts of a map in accordance with a stated rationale. Users may opt to keep such views private to themselves, or make them available to other users. To create such a view, the user selects CreateView from Actions drop-down list. When this is done, the map is re-rendered with checkboxes visible alongside each node (except for the MapDescription and Deleted nodes), the textboxes on the main panel are enabled, and the confirmation button 7 (FIG. 8) is visible with text ‘Save view’ below the text boxes. By default each box is checked. The user can uncheck boxes to exclude them, and their sub-trees. The user enters a title for the view and a description of it in textboxes 4 and 5 (FIG. 8) on the main panel, and then clicks the confirm button. The selective view is then stored in the UserViews table in the database, with a column storing a delimited string of all the excluded node's unique identifiers. The new selective view is added to drop-down list 5 of such views on the settings panel (FIG. 14). When a selective view is displayed, the code that builds the treeview ensures the excluded nodes are not added.
A linear document can be generated corresponding to a displayed map as follows. The user makes sure the relevant map portion is displayed, and the desired starting point node for the document is selected, and the desired format option for the document is selected using drop-down list 6 (FIG. 11) visible above the display area, and then selects GenerateDocument from the drop-down list. This causes application code to be executed that retrieves the data table used to populate the map from the session object and to then, beginning at the data row corresponding to the currently selected node, recursively builds an XML document that encodes the data using string and stringbuilder methods. The document is then rendered by transforming the raw XML document with one of a number of XML transformations stored on the web server depending on which document format has been selected. The described implementation provides three document format option: a table of contents format using the brief text; the brief text and the verbose text for each node with links to any specified elaboration of the node contained in a separate document, and the preceding format with an added header made up of node metadata.
The final normal action option is PrinterFriendlyView, which transfers the user to a different ASP.NET web page where the map or generated document is shown in isolation in a format suitable for printing. Information needed for this rendition is held in the session object so it can be retrieved for rendition following the page transfer.
Users with administrator permission either for the currently displayed map or for the whole repository will also have an Administer option. Map and repository administration is described in a section below.

### 3.8.2 Editing Actions

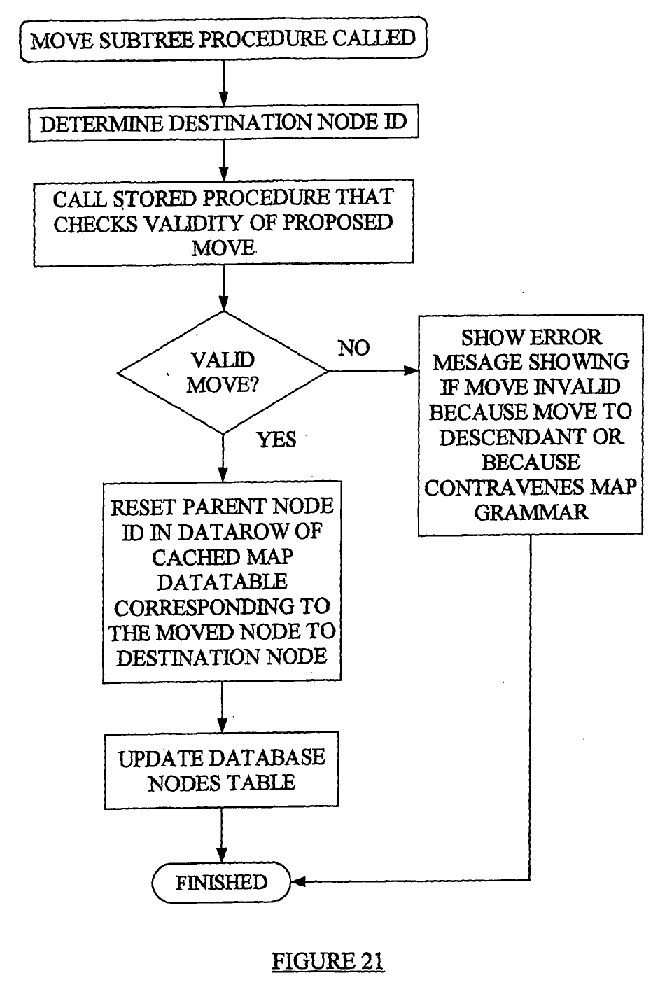

Options presented to the user on the Actions drop-down list when the application is in EDIT mode are described below. Application code ensures that editing can only be performed by users with Editor permission or higher. Validator controls are used to ensure that user input conforms to any requirements as to length and format, and further checks are performed programmatically to ensure that only well-formed XML fragments are entered and to preclude malicious code. The permission system is described in a later section. In general, the editing process works by application code changing relevant values in the table of currently displayed map data held in session state. When an action is confirmed by the user clicking the relevant button after entering or editing information, the updated table is propagated back to the database. In the course of this updating any relevant checks (e.g. for concurrency violations) are performed and messages displayed to the user either confirming the success of the action or displaying an error message.
When the user selects EditNode on the Actions drop-down list, the text boxes on the main panel (FIG. 4) are enabled so the user can edit text. The user can enter simple HTML formatting if desired, as well as some DebateMapper-specific markup characters and tags (described in a later section). The user can also opt to lock or unlock the node using checkbox 3 (FIG. 8). Locked nodes can only be edited or deleted by the node's author or a user with administrator permission. At any stage, the user can click Show button (item 6, FIG. 8) visible below the editing text boxes to see a draft of texts, with any embedded HTML markup applied, in the secondary panel area (provided the verbose text option has been selected to be displayed in this area).
The user selects AddChild to add a new node to the currently selected node. This action clears and enables the textboxes (4 and 5) on the main panel so the user can enter brief and verbose texts for the new node. If the user wishes to add a tooltip, this appended to the end of the verbose text delimited by a pipe ‘|’ symbol. The user must select a type for the node using drop-down list 2 of types permitted in this position by the current map's grammar. The user can select a check box to lock the node so that it can only be edited or deleted by the author or an administrator. While entering texts, the user can view the result (and be advised of the total character length) by clicking Show (button 6). This causes the node texts, with any formatting applied, to be displayed in the secondary panel area. The use clicks the Confirm new node button to finalize the process.
A node (and its subtree) can be moved to a different location in the map, or to a location in a different map with the same map grammar, by first selecting the node to be moved and then choosing the MoveSubtree option on the Actions drop-down list. The user is then prompted to select a destination node by either left-clicking a node on the currently displayed map portion or by selecting a bookmarked location using the Bookmarks drop-down list in the navigation cluster (item 8, FIG. 6). The user is prompted to confirm the move by clicking Confirm move, which causes the parent identifier value in the data row corresponding to the to-be-moved node to be changed to the selected destination node and the change to be propagated back to the Nodes table in the database. The same effect can be achieved by dragging and dropping the node to its new destination. This behavior is supported by the proprietary treeview product used in the current implementation. The drag and drop move raises an event which can be programmed against to change the parent identifier of the moved node. FIG. 21 is a flowchart showing how application logic responds when the user attempts a subtree move.
A CrossReference node, the special functionality of which is described above, can be added to another node by choosing the AddCrossReference option. In the current implementation, the location to be cross-referenced must be a bookmarked location. The user is prompted to enter a brief text for the CrossReference node in textbox 4 (FIG. 8). The application stores the cross-referenced node's primary key value in the verbose text column of the Nodes table (hence nothing can be entered in the verbose textbox 5, which is disabled). The user is prompted to select a bookmarked location as destination. The user clicks the confirm button to complete the operation.
The Delete action moves the currently selected node to the Deleted node visible at the bottom of each map, from where it can be restored if desired. The latter node is analogous to the trash bin on the Windows desktop. The user is asked to confirm the deletion, which results in the table of map node data to be modified and the change propagated to the database.
PermanentDelete is an administrator-only action that, rather than moving the node to the particular map's Deleted node, moves it to a repository-wide Deleted node visible only to users with permission to administer the entire repository. It can still be restored from there by administrators. The data is finally removed from the database when the GarbageDisposal database stored procedure is run, either at the initiative of an administrator or as a scheduled database job. This procedure recursively deletes all nodes descended from the repository-wide Deleted node.
Map data can be exported in an XML format by displaying the relevant map portions, selecting a starting point node and selecting the SaveAsXML option from the drop-down list. The user is then prompted to enter a filename (without extension) in the brief text box and prompted confirm the save. After confirmation, the XML document is stored in the users individual folder on the server from where it can be accessed on the web page used for managing resources.
Node data can be imported into a map from an XML document having the same schema as produced by SaveAsXML by selecting the InsertFromXML action on the drop-down list. The user is prompted to enter a URL for the inserted document and to confirm the save. The XML document is validated and, if valid, the data is recursively extracted (using XML document object methods) and inserted into the database.
The CloneSubtree action copies the currently selected node and its subtree to a new location selected in the same manner as for MoveSubtree. In the current implementation, this action is achieved by the application logic generating an XML document in the same format as produced by SaveAsXML and inserting a new copy of the subtree in the new location using the same programming logic as InsertFromXML.
SubstituteNode is an administrator-only action whereby an administrator can ‘promote’ an alternative wording of a node's texts that has been proposed (by adding an AlternativeWording node as a child to the proposed-to-be-changed node) by a user with Commentator, Editor or Administrator permission. The effect of this action is to replace the parent node's texts with those in the AlternativeWording, and then delete the AlternativeWording node.

### 3.9 The DebateMapper Permission System

DebateMapper has a permission system that governs the ways that users can interact with maps and associated resources, carry out administrative activities and market items. Every user must have login credentials (user name and password) as well as a collection of permissions herein termed a ‘permission set’. Each permission set contains one, and only one, permission level that applies to the entire repository of maps and resources. This is termed the user's ‘generic permission’. Each user may additionally have a number of permissions that stipulate what the user can do with a specific map and resources associated with its constituent nodes. Each of these is termed a ‘map specific permission’. The relational database contains separate tables of information about each user, each generic permission and each map-specific permission. The tables are related appropriately with foreign key constraints that ensure data integrity—for example, if a user is deleted from the Users table, all generic and map-specific permissions associated with that user are automatically deleted.

In the described implementation, the following generic permission levels are available (ordered from lower to higher privileges):
Generic Viewer permission allows the user to browse any maps in the repository provided the map access level is set to ‘public’. The user can interact with the map in limited ways, including book-marking of nodes and the creation and storing of selective views.
Initiator permission allows the user to also begin a new map using the method described in Section 3.6.
Vendor permission allows the user to offer items for sale in conjunction with map nodes and resources, as described in Section 3.12.
Generic Administrator permission enables the user to carry out certain administrative functions that pertain to the entire repository, as well as to administer any map. This includes assigning and changing both generic permissions and any map-specific permission levels.

Note that for both generic and map-specific permissions, higher levels encompass all the rights associated with all lower levels.

In the described implementation, the following map-specific permission levels are available (ordered from lower to higher privileges):
Viewer permission provides the same privileges as for the generic viewer case, but only for a particular map.
Commentator permission additionally permits the user limited editing rights for the map, consistent with the role of commentator rather than structural editor. The user may add comments at any point in the map structure permitted by the grammar, and can also add AlternativeWording nodes that suggest alternative wordings of its parent node (map administrators may ‘promote’ this proposed alternative, as described in Section 3.8.2)
Editor permission provides full editing rights for the map, with the exception of those actions reserved to administrators.
Administrator permission allows the user to administer the specific map only. As well as providing certain administrator-only editing actions (such as permanently deleting a node, or substituting a proposed alternative wording of a node), map administrators may assign or change permission levels for the map using controls on the Administrator web page.

Someone applies to become a DebateMapper user by entering relevant information and requests for various permission levels using a web form. The user applies for a single generic permission level, and for map-specific permissions for the maps the user is interested in. Such permission applications are accumulated and presented for review and editing by the user before the form is submitted. When the user submits this form, a stored procedure is called which does the following:
Checks that the proposed user name and passwords have not already been used. If they have, the operation is aborted and the user is prompted to provide an alternative.
Enters the user's basic information, including user name and password in a new row of the Users table
Inserts a row in the GenericPermissions table in which the new user is assigned ‘Applicant’ status, and the applied-for role is entered in a separate column;
If the user has applied for any map-specific permissions, an entry is made for each in the MapPermissions table, again with the user status entered as ‘Applicant’, and each applied-for role entered in a separate column.

This information can then be reviewed by an administrator using the Administrator web page, who can grant the applied-for permission level using the controls on this web page. When a user is first granted permission to use the system, or when any permission levels are altered by administrators, an email message advising the user of the changes is automatically generated. A unique user folder on the web server for storing uploaded and saved files is also automatically created. When a user logs in to the application on the DebateMapper entry page, all that users current permission levels are displayed in a message panel, and a drop-down list of maps to which the user has access is populated.

### 3.10 Building Map-Based Information Repositories

DebateMapper provides a new method of organizing the multitude of information items on the web that pertain to major issues and debates by building databases of resources and subsets or transformations of them around maps of the underlying structures of argumentation. Relevant information items may take a variety of forms: web sites, discussion group postings, articles, papers, multimedia items, queries, and so on. The key global regulatory body for the internet, the Internet Engineering Task Force (IETF), has defined a ‘resource’ as ‘any unit of information or service that can be addressed using a URI (Uniform Resource Identifier). These could be files, images or other multimedia objects, documents, programs and query results’ (IETF RFC 2396). The implementation described in this document takes this basic definition but also provides for the inclusion of a second document, termed a ‘subset selector’, which specifies a subset, re-ordering or other transformation a parent resource. The basic idea is that a long article, for example, may have a complex argumentation structure, and analyzing such a structure will require breaking it down into its component argumentative parts.

Hence, throughout this specification, a resource is defined as a parent item (termed the ‘source’) together with an optional subset selector. In the implementation described here, the format for subset selectors is the W3C standard XML transformation language (XSLT) in the case of textual source documents, and Synchronized Multimedia Integration Language (SMIL) in the case of multimedia source items such as audio-visual clips and media presentations. DebateMapper allows the association of an arbitrary number of resources with each map node, together with a standard set of searchable metadata, and supports a multiplicity of options for viewing such resources in different formats. These features are described below.

3.10.1 Method for Adding Resources

To associate a resource with a map node, the user first loads the relevant part of the map on the ViewMap page, selects the relevant map node by left-clicking it, and then enters EDIT mode by clicking the mode selector (radio-button 2 of FIG. 4, see also FIG. 10) The user then selects AddResource on the Actions (drop-down list 1 of FIG. 8) This causes the execution of application code that transfers the user to a different DebateMapper page, the AddResource page, that provides an interface enabling the user to enter relevant information about the resource and insert it into the database. This implementation broadly follows developing international standards for resource metatadata and includes such items as title, creator, date, description, keywords, as well as the type and technical format of the resource (text/xml, image/gif, video/mpeg etc).

The user must specify the URL from which the source document can be retrieved and the URL of any subset selector. These can be directly entered in textboxes on the page. Alternatively, the source item and/or the subset selector can be uploaded from the user's computer to the server using an HTML file input control on the page. The file to be uploaded is selected by clicking the browse button on the interface, which causes the user's local file system to be displayed. The user then browses to the item and selects it. Each user has an individual folder in which such uploaded items are stored on the web server. Administrators can set the maximum uploaded file size, and the maximum size of each user's folder, using controls on the Administration web page (as an alternative method would be to store uploaded items in the database itself in either text or binary format). Other controls enable the user to retrieve a list of all uploaded files (either just the user's uploads, or all files that have been linked to map nodes by any user). When the user selects one of these items, the URL for the item is automatically entered into either the textbox for the source URL or for the subset selector URL (the user selects using a radio-button list control).

DebateMapper also allows users to stipulate that Microsoft Word and Rich Text Format files uploaded from their computer to the web server be converted, after uploading, to either XHTML or Microsoft Reader electronic book format. This feature is implemented by incorporating a dynamic link library (DLL) version of the Logictran R2Net converter. This exposes methods that can be called from application code to carry out the conversion process. These converted versions are also stored in the user's individual folder.

Once all relevant fields have been completed, the user enters the item by clicking a submit button. Application code then inserts a row of information about the new resource in the Resources table, and a database trigger updates the column in the Nodes table that stores the number of resources associated with the node with which the resource is to be associated. If the user stipulates that the type attribute of the uploaded file (not to be confused with its physical format) is an ‘elaboration’, i.e. a detailed exposition, of unrestricted length (apart from storage considerations) of the semantic content of the node with which it has been associated, the URL of such elaboration and any associated subset selector is entered in the corresponding columns of the Nodes table as part of the updating process.

3.10.2 Method for Specifying Subset Selectors

### Case 1: Source is a Text Document Conforming to XML/XHTML

DebateMapper allows users to specify a subset selector for any text document that conforms to the World Wide Web (W3C) XML specification (this includes XHTML, the XML conformant version of the HTML markup language). The subset selector must be an XML transformation language (XSLT) document. The transformation is performed by application code that utilizes the classes of the System.Xml.Xsl namespace to perform the transformation. The document is normally rendered (following the transformation) on an application web page using an ASP.NET xml control.

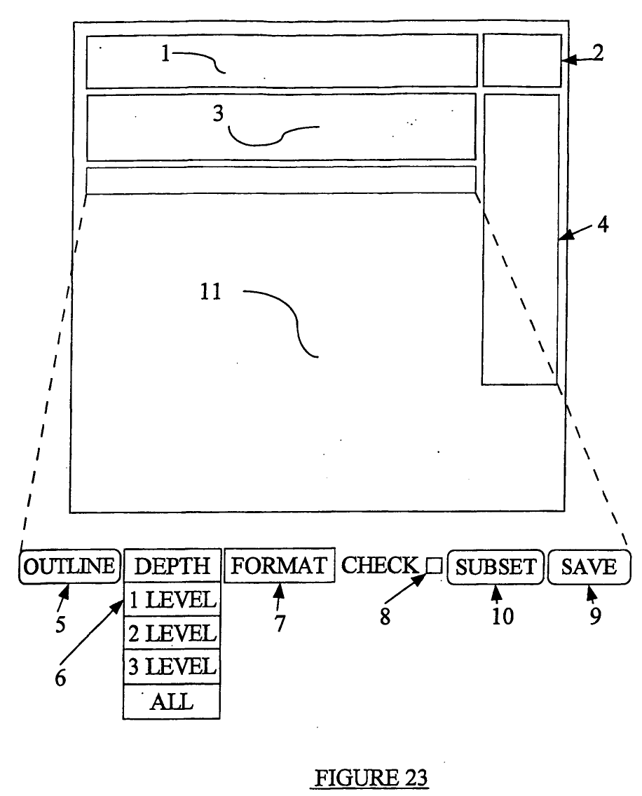

There are two methods for specifying the subset selector in this case:
1. DebateMapper includes a web page that allows users to easily create a subset selector for an XML/XHTML document without requiring any knowledge of the XSLT language (see FIG. 23 for a schematic diagram of this page). After entering resource metadata and specifying the source document URL using the methods described above, the user clicks a button that preserves all the information already entered on the page in session state and transfers the user to a web page which provides an interface for specifying document subsets. When this page is first loaded, the source document is rendered on an ASP.NET xml control. By clicking the Show outline button (item 5 of FIG. 23), the user calls application logic that gives each element in the xml document a unique ID attribute. The document is also rendered in outline format by building a treeview control that shows the first part of the text content of each element. The full text of each element can be viewed in a tooltip by moving the mouse over the relevant treenode. The tooltip also includes the element type (h1, div, span etc). The element type is also indicated by node color-coding. Each element in the displayed outline has a checkbox. The user can specify which document parts are to be included in the subset by checking or un-checking boxes. The user can view the selected document subset at any stage by clicking Show subset (button 10). When the user is satisfied with the selection, Save (button 9) is clicked. This causes code to execute that reads off the checked/unchecked nodes from the treeview control and programmatically writes out and saves to the user's folder an XML transformation document which, when applied to the source document, outputs the required document subset. The user then returns to the Add resource page (by clicking the relevant navigation button), where the state of all controls should have been restored and the URL of the newly minted subset selector (with file extension .xslt) is visible in the Selector URL textbox.
2. Users with the necessary knowledge may write the XSLT code directly using any text editor and then making it available on the web by uploading it to the application server. It can then be selected as described above as the subset selector for some resource.

### Case 2: Source is One or More Multimedia Items

DebateMapper allows users to add a subset selector for a multimedia item, such as an audio-visual clip. The method involves using a web page termed the Multimedia Selector Builder. By using this page, the user can output a document using the W3C standard Synchronized Multimedia Integration Language (SMIL) syntax without requiring any special knowledge of this language. The method is as follows: After entering metadata and selecting a source item as described above for text documents (except this would me a media item such as a .mpeg file) the user transfers to the Multimedia Selector Builder page by clicking the Build multimedia button When this page is displayed, the user gives the media selector a title by entering in the relevant textbox. A drop-down list will have been populated, by code executing in the page load event, with the title of each item in the user's folder which is in a suitable media format. The user selects one such item and then specifies a duration for the item by entering in a textbox. If it is a continuous media item (e.g. a video clip) the user can specify a beginning and end time for the clip by entering it (in seconds) in the ClipBegin and ClipEnd textboxes. The user also gives the presentation segment a title, and selects the type of media item using a drop-down list. The user can also enter a text which remains visible next to the segment while it plays. The above steps can be repeated for additional segments from the same media item, or another item on the drop-down list. When finished, the user selects a format for the presentation. The two current presentation format options are termed button play, where a button appears for each segment and the user clicks to play, or sequential, in which the segments are played one after another.

The user completes the process by clicking the Build button, which causes application code to write out and save a document in the HTML+TIME syntax (which is Microsoft's implementation of SMIL) which embeds SMIL timing elements within HTML documents. The presentation can be played by loading the resultant document into a browser.

3.10.3 Methods for Viewing Resources

When a node is rendered on a map, DebateMapper signifies that the node author has added an ‘elaboration’ (a long article expanding on a node's content) or that the node has had other resources (articles, media items etc) associated with it by map editors by appending an ‘e’ or an ‘r’ to the displayed node text respectively. Information about elaborations and resources is also displayed on a metadata panel in the secondary panel area (item 3 of FIG. 13), unless the user has opted to show something other than the verbose text in this area.

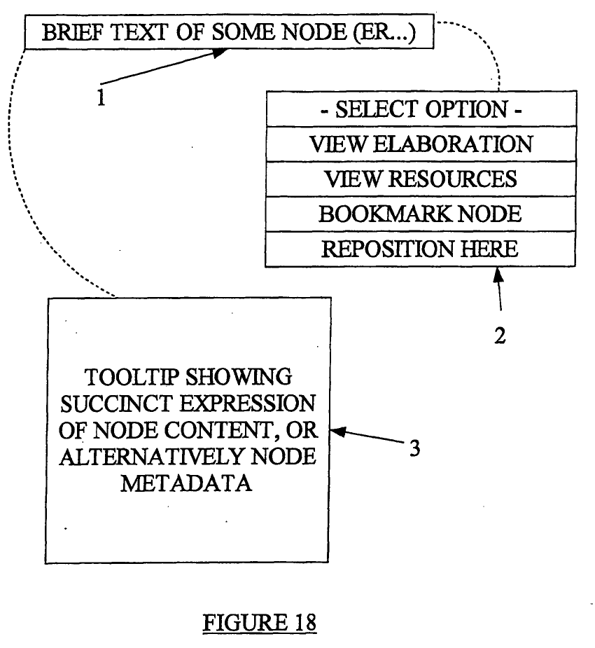

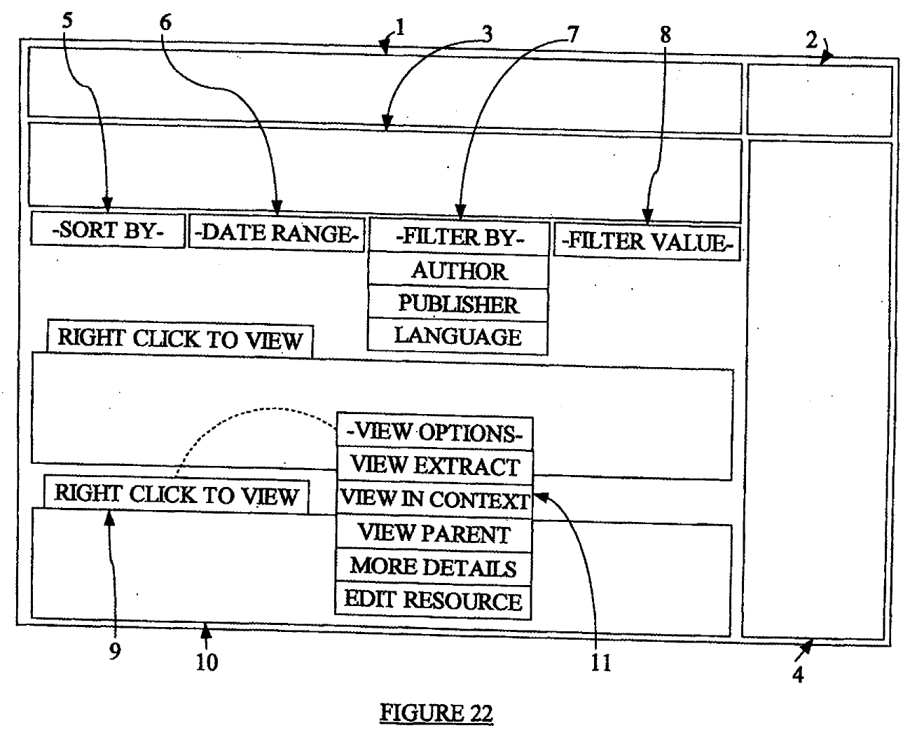

To view a table of resources associated with the node, the user first right-clicks the node. This causes a context menu to appear (this functionality supported by a number of proprietary treeview controls). A schematic diagram of a node with the above trailing symbols and a context menu showing is at FIG. 18. The user selects View resources (list item 2) to transfer to the user to a web page for displaying resource information (the Resource Information Panel). When this page is loaded, a database query retrieves information about all the resources that have been associated with this node (see FIG. 22 for schematic diagram). A set of information about each of these resources is displayed sorted (initially) by resource title (a more complete set of metadata about each resource can be viewed using the context menu described below). Drop-down list 5 of FIG. 22 can be used to select other sort options, including the option of sorting by average user evaluation of the resource. At the top of each item in the table of resources is tab 9 with text ‘Right-click here for options’. Right-clicking causes context menu 11 to be displayed showing the available formats for viewing the resource. This will vary depending on the type of resource: for example, uploaded rich text format or Microsoft Word documents may have been converted to both XHTML and Microsoft Reader electronic book format. Also, resources that have an XSLT subset selector can be viewed with all resource subsets extracted from their context in the parent document and concatenated (with a horizontal line indicating non-contiguous segments); or can be viewed with the resource subset(s) displayed highlighted in context of the parent document. Other context menu items allow the user to view a more detailed set of metadata than is initially displayed, or to view the parent document (if a subset) without any highlighting. If the user is either the original contributor of the resource, or has administrator privileges, an additional Edit resource info context menu item should also be visible.

The options to view document subsets within the parent document context, or extracted from that context, are implemented by programmatically passing a parameter to the XML transformation which is executed before rendition. Conditional logic within the transformation itself uses the parameter value to determine which of two transformation options is applied: one which includes the full text and applies a set of CSS style attributes to highlight the subset, or one which excludes all text not included in the subset (with non-contiguous sections separated by horizontal lines).

Unlike the verbose text, which is stored in the Nodes database table, an elaboration is stored in the user's folder in the web server file system. The user can view such an elaboration by right clicking the relevant node, causing a context menu to appear. Selecting the View elaboration item causes the user to be transferred to another application web page, where the elaboration is rendered using an ASP.NET xml control. If the elaboration is a subset of a larger document, the elaboration is, by default, displayed highlighted in the parent document context.

3.10.4 Resource Table Viewing Options

Controls on the Resource Information Panel web page provide a number of options for sorting and filtering the resource table. The Sort by drop-down list (item 5 of FIG. 22) can be used to select different sort criteria (e.g. by title, or by average user evaluation). The Date range drop-down list 6 can be used to specify a time filter (e.g. resources contributed in last week, or last month etc). Drop-down list 7 allows the user to select a Resource table column value to filter by (author, publisher, language, format etc). When the choice of filter has been made, a database query is executed which returns all distinct (using SQL SELECT DISTINCT syntax) values contained in the data for the specified column (e.g. all distinct authors, excluding repetitions where the same name recurs in different resources). The Filter value drop-down list 8 is then populated with a sorted list of these distinct values. When the user selects one of these, only resources associated with the node that meet the filter criteria (e.g. works by the specified author, publisher, etc) are displayed in the table. After selecting all the desired sorting and filtering criteria, the user clicks Reload button. This causes the application to read these control values and construct a database query string accordingly, to execute this query and re-populate the resources table.

3.10.5 Editing Resource Data

Resources, once added, can have their information edited, or can be deleted from the database, by the user who originally contributed the resource or an administrator. When a resource table is displayed on the Resource Information Panel, each item is assigned a context menu depending on the available viewing options. If the user has editing permission for the resource, an Edit resource info is visible on the context menu which appears when the tab above the resource is right-clicked (item 11 of FIG. 22). When this option is selected, an editing panel is displayed in place of the resource table with text boxes populated with current information and enabled for editing. After editing, the user clicks the Enter changes button to propagate the changes back to the database Resources table. Clicking the Delete resource button causes the resource to be removed from the database. Note that this does not remove any actual resource files in the user's folder—this must be done separately using the Manage Uploads web page.

### 3.11 Administration

DebateMapper provides for two type types of Administrator role:
Generic administration concerns the entire repository of maps and resources of a particular DebateMapper installation.
Map-Specific administration concerns the administration of a specific map and its associated resources.

For most purposes, administrators use the DebateMapper Administration page. This panel is used for both generic and map-specific administration, though certain controls are enabled/disenabled and behave differently in the two cases. Sections below describe the two types of administration in more detail.

3.11.1 Generic Administration

A user with Generic administrator permission can carry out a range of administrative functions that apply to the entire repository of maps, resources and users. These functions are:
Assigning both generic and map-specific permissions to users.
Deleting users and all their permissions.
Enabling or disenabling node and resource evaluation and shopping for any map in the repository.
Setting the maximum permitted size of uploaded user files.
Setting the maximum user folder size.
Running the GarbageDisposal stored procedure, which permanently deletes from the database nodes and subtrees marked for permanent deletion.
Backing up the database, or setting the schedule for database backups.
Viewing the event log for the application which shows who has logged in and signed out, and at what times.

All of these functions are carried out using the DebateMapper Administration page. Note that generic administrators can exercise the map-specific administrator role for any map in the repository.

3.11.2 Map-Specific Administration

Map-Specific Administration applies to a specific map and its associated resources. A user may have a number of map specific administrator permissions for different maps. Map-specific administration includes the following functions:
Assigning permissions to users of the map to which the permission applies.
Permanently deleting nodes and subtrees from the specified map (this means moving them to the repository-wide Deleted node, thereby marking them for permanent removal from the database the next time the GarbageDisposal database procedure is run).
Viewing any map nodes, including any PrivateSpace nodes and their subtrees.
Editing or deleting any nodes, including nodes locked by their authors.

These functions are performed by users with permission to administer a specific map using the Administrator web page with certain functions available only to generic administrators hidden or disabled.

### 3.12 Marketing Items

DebateMapper includes features that enable users with Vendor permission to offer items for sale in conjunction with node resources. This feature must be activated for each map by a Generic administrator. The basic idea is that as users browse maps, nodes and resources of different kinds associated with them, related items can be offered for sale. Such items may be the full printed or electronic versions of books or multimedia items that have been excerpted to support or illustrate the argumentative point made in a map node, or any other item that might be thought to sell in this context (e.g. holiday travel to a mentioned location). Users can accumulate items in a shopping cart during a browsing session before proceeding to a checkout page where the order can be finally edited and processed using a proprietary solution. The basic features of the DebateMapper resource marketing system are as follows:
In order to market items, a user must have generic Vendor permission. This can be applied for when applying for, or amending, a Permission Set.
The user can then enter items which can be offered for sale into the application database for sale using an interactive web page designed for this purpose. With controls on this page, the user can enter the item's name, description and price, along with URLs for more information and for a graphic (to accompany display ads). The user can also enter information about the context in which the item is to be displayed and promoted, for example when information about a particular or resource, or class of resources, is being viewed by the user. The application can be integrated with a standard shopping cart application which permits users to accumulate purchases while browsing maps and resources before going to a checkout page and to automatically generate and display purchase suggestions based on the user's browsing.
A special node type is available for promoting items in the context of maps. Users with Vendor permission may add these to other nodes as specified in the relevant map grammar. By default, or at user discretion, these nodes can be filtered in or out using the listbox control for filtering by node type that appears on the settings panel (refer listbox 4 in FIG. 14). In the case of such node types, the user may right-click the node to see a context menu (as with all node types), with items that enable the user to view more information about or to purchase the item.

### 3.13 DebateMapper Help System

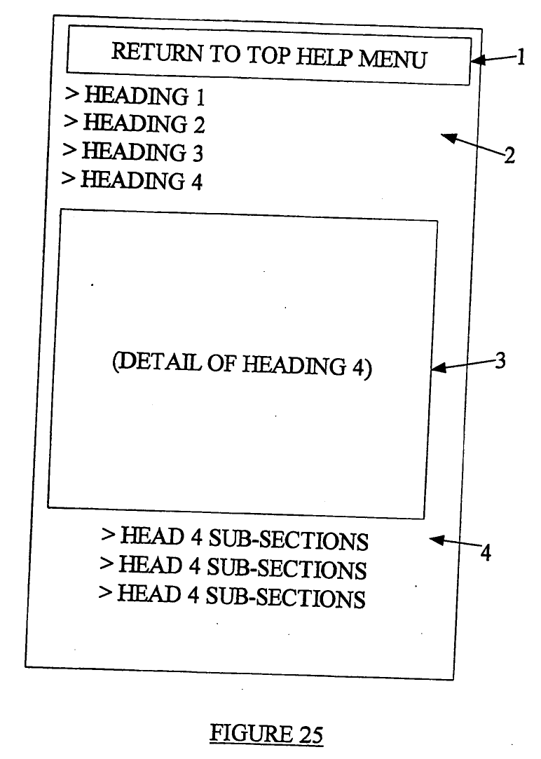

This specification includes an online Help System with some distinctive features made possible by the fact that the Help System is, in fact, a map with its own simple grammar. The same middle-tier components are used for retrieving and preparing data for the Help system as for any other map. The data may be viewed either on the page normally used for viewing and editing maps (the ViewMap page) or on a special Help System control which can be made visible on the left of most application pages (see FIG. 25 for a schematic view of this control). Users with relevant permission can edit the system in either limited ways (such as adding comments or annotations) or comprehensively (for administrators only). The Help System control is implemented as an ASP.NET User Control, making it easy to add to all appropriate pages. Having clicked a control to make the Help System control visible, the user interacts with it in much the same way as described in Section 3.5 for viewing maps in BROWSE mode. An initial table of contents is shown collapsed (item 2 of FIG. 25). When the user expands any item, the full text of that item is rendered on a panel 3 immediately below (with style characteristics as set in the style class for the node type), with headings of any sub-section children 4 of the selected item appearing below. Any of these can be expanded at user discretion. Retrieval of information throughout this process is handled using a server callback mechanism implemented by a proprietary treeview control making for relatively rapid population of the control in response to user inputs. The user can revert to the top menu of the Help System at any time by clicking button 1.

An XML document specifying the encoding of a map grammar is as follows:

Program code module 1

```
<?xml version=“1.0” encoding=“utf-8” ?>
<NODEGRAMMAR>
    <ContentRules>
        <AllowedChildren NodeType=“MapDescription”>
            <ChildType Name=“OpeningIssue” />
            <ChildType Name=“AlternativeWording” />
            <ChildType Name=“Notes” />
            <ChildType Name=“Discussion” />
            <ChildType Name=“PrivateSpace” />
        </AllowedChildren>
        <AllowedChildren NodeType=“OpeningIssue”>
            <ChildType Name=“IssueArising” />
            <ChildType Name=“Contention” />
            <ChildType Name=“AlternativeWording” />
            <ChildType Name=“Notes” />
            <ChildType Name=“Discussion” />
            <ChildType Name=“PrivateSpace” />
        </AllowedChildren>
        <AllowedChildren NodeType=“IssueArising”>
            <ChildType Name=“IssueArising” />
            <ChildType Name=“Contention” />
            <ChildType Name=“AlternativeWording” />
            <ChildType Name=“Notes” />
            <ChildType Name=“Discussion” />
            <ChildType Name=“PrivateSpace” />
        </AllowedChildren>
        <AllowedChildren NodeType=“Contention”>
            <ChildType Name=“IssueArising” />
            <ChildType Name=“Aggregator” />
            <ChildType Name=“Qualification” />
            <ChildType Name=“Authorizer” />
            <ChildType Name=“AlternativeWording” />
            <ChildType Name=“Notes” />
            <ChildType Name=“Discussion” />
            <ChildType Name=“PrivateSpace” />
        </AllowedChildren>
        <AllowedChildren NodeType=“Qualification”>
            <ChildType Name=“IssueArising” />
            <ChildType Name=“Aggregator” />
            <ChildType Name=“Qualification” />
            <ChildType Name=“Authorizer” />
            <ChildType Name=“AlternativeWording” />
            <ChildType Name=“Notes” />
            <ChildType Name=“Discussion” />
            <ChildType Name=“PrivateSpace” />
        </AllowedChildren>
        <AllowedChildren NodeType=“Authorizer”></
        AllowedChildren>
        <AllowedChildren NodeType=“Aggregator”>
            <ChildType Name=“SupportivePoint” />
            <ChildType Name=“OpposingPoint” />
            <ChildType Name=“Warrant” />
        </AllowedChildren>
        <AllowedChildren NodeType=“SupportivePoint”>
            <ChildType Name=“IssueArising” />
            <ChildType Name=“Aggregator” />
            <ChildType Name=“SupportivePoint” />
            <ChildType Name=“OpposingPoint” />
            <ChildType Name=“AlternativeWording” />
            <ChildType Name=“Notes” />
            <ChildType Name=“Discussion” />
            <ChildType Name=“PrivateSpace” />
        </AllowedChildren>
        <AllowedChildren NodeType=“OpposingPoint”>
            <ChildType Name=“IssueArising” />
            <ChildType Name=“Aggregator” />
            <ChildType Name=“SupportivePoint” />
            <ChildType Name=“OpposingPoint” />
            <ChildType Name=“AlternativeWording” />
            <ChildType Name=“Notes” />
            <ChildType Name=“Discussion” />
            <ChildType Name=“PrivateSpace” />
        </AllowedChildren>
        <AllowedChildren NodeType=“Warrant”>
            <ChildType Name=“IssueArising” />
            <ChildType Name=“Aggregator” />
            <ChildType Name=“Qualification” />
            <ChildType Name=“Authorizer” />
            <ChildType Name=“AlternativeWording” />
            <ChildType Name=“Notes” />
            <ChildType Name=“Discussion” />
            <ChildType Name=“PrivateSpace” />
        </AllowedChildren>
        <AllowedChildren NodeType=“AlternativeWording”></
        AllowedChildren>
        <AllowedChildren NodeType=“CrossReference”></
        AllowedChildren>
        <AllowedChildren NodeType=“Notes”>
            <ChildType Name=“Annotation” />
        </AllowedChildren>
        <AllowedChildren NodeType=“Discussion”>
            <ChildType Name=“Comment” />
        </AllowedChildren>
        <AllowedChildren NodeType=“Comment”>
            <ChildType Name=“Comment” />
        </AllowedChildren>
        <AllowedChildren NodeType=“PrivateSpace”>
            <ChildType Name=“OpeningIssue” />
            <ChildType Name=“IssueArising” />
            <ChildType Name=“Contention” />
            <ChildType Name=“Qualification” />
            <ChildType Name=“Aggregator” />
            <ChildType Name=“SupportivePoint” />
            <ChildType Name=“OpposingPoint” />
            <ChildType Name=“Warrant” />
            <ChildType Name=“AlternativeWording” />
            <ChildType Name=“Notes” />
        </AllowedChildren>
        <AllowedChildren NodeType=“Deleted”></AllowedChildren>
    </ContentRules>
    <NormalActions>
        <AllowedNormalActions NodeType=“MapDescription”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“OpeningIssue”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“IssueArising” >
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“Contention”>
            <NormalAction Name=“Add Bookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“Qualification”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“Authorizer”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“Aggregator”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“SupportivePoint”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“Opposing Point”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“Warrant”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“AlternativeWording”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions
NodeType=“CrossReference”></AllowedNormalActions>
        <AllowedNormalActions NodeType=“Notes”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“Annotation”>
            <NormalAction Name=“AddBookmark” />
            <NormalAction Name=“GenerateDocument” />
            <NormalAction Name=“PrinterFriendlyView” />
        </AllowedNormalActions>
        <AllowedNormalActions NodeType=“Discussion”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“Comment”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“PrivateSpace”>
            <NormalAction Name=“AddBookmark” />
            <NormalAction Name=“CreateView” />
            <NormalAction Name=“GenerateDocument” />
            <NormalAction Name=“PrinterFriendlyView” />
        </AllowedNormalActions>
        <AllowedNormalActions NodeType=“Deleted”></
        AllowedNormalActions>
    </NormalActions>
    <EditActions>
        <AllowedEditActions NodeType=“MapDescription”>
            <EditAction Name=“EditNode” />
            <EditAction Name=“AddChild” />
            <EditAction Name=“AddResource” />
            <EditAction Name=“AddCrossReference” />
            <EditAction Name=“SaveAsXML” />
            <EditAction Name=“InsertFromXML” />
        </AllowedEditActions>
        <AllowedEditActions NodeType=“OpeningIssue”>
            <EditAction Name=“EditNode” />
            <EditAction Name=“AddChild” />
            <EditAction Name=“DeleteNode” />
            <EditAction Name=“AddCrossReference” />
            <EditAction Name=“AddResource” />
            <EditAction Name=“SaveAsXML” />
            <EditAction Name=“InsertFromXML” />
        </AllowedEditActions>
        <AllowedEditActions NodeType=“IssueArising”>
            <EditAction Name=“EditNode” />
            <EditAction Name=“AddChild” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“Contention”>
            <EditAction Name=“EditNode” />
            <EditAction Name=“AddChild” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“Qualification”>
            <EditAction Name=“EditNode” />
            <EditAction Name=“AddChild” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“Authorizer”>
            <EditAction Name=“DeleteNode” />
        </AllowedEditActions>
        <AllowedEditActions NodeType=“Aggregator”>
            <EditAction Name=“EditNode” />
            <EditAction Name=“AddChild” />
            <EditAction Name=“MoveSubtree” />
            <EditAction Name=“CloneSubtree” />
            <EditAction Name=“DeleteNode” />
            <EditAction Name=“SaveAsXML” />
            <EditAction Name=“InsertFromXML” />
        </AllowedEditActions>
        <AllowedEditActions NodeType=“SupportivePoint”>
            <EditAction Name=“EditNode” />
            <EditAction Name=“AddChild” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“OpposingPoint”>
            <EditAction Name=“EditNode” />
            <EditAction Name=“AddChild” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“Warrant”>
            <EditAction Name=“EditNode” />
            <EditAction Name=“AddChild” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“AlternativeWording”>
            <EditAction Name=“EditNode” />
            <EditAction Name=“SubstituteNode” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
        </AllowedEditActions>
        <AllowedEditActions NodeType=“CrossReference”>
            <EditAction Name=“EditNode” />
            <EditAction Name=“DeleteNode” />
        </AllowedEditActions>
        <AllowedEditActions NodeType=“Notes”>
            <EditAction Name=“EditNode” />
            <EditAction Name=“AddChild” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“Annotation”>
            <EditAction Name=“EditNode” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“Discussion”>
            <EditAction Name=“EditNode” />
            <EditAction Name=“AddChild” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“Comment”>
            <EditAction Name=“EditNode” />
            <EditAction Name=“AddChild” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“PrivateSpace”>
            <EditAction Name=“EditNode” />
            <EditAction Name=“AddChild” />
            <EditAction Name=“MoveSubtree” />
            <EditAction Name=“CloneSubtree” />
            <EditAction Name=“AddCrossReference” />
            <EditAction Name=“DeleteNode” />
            <EditAction Name=“AddResource” />
            <EditAction Name=“SaveAsXML” />
            <EditAction Name=“InsertFromXML” />
        </AllowedEditActions>
        <AllowedEditActions NodeType=“Deleted”></
        AllowedEditActions>
    </EditActions>
</NODEGRAMMAR>
```

An ontology specifying a set of node types can be as follows:

```
<TREENODETYPES>
    <TreeNodeType TYPE=“MapDescription” SortPriority=“01” ID=“MapDescription”
Description=“Each map contains a single MapDescripion node which describes the broad subject
matter of the map. It is the root of the map argument tree.” EvalQuestion=“” />
    <TreeNodeType TYPE=“OpeningIssue” SortPriority=“10” ID=“OpeningIssue”
Description=“One of the initial issues to be addressed in the map (there may be a number). Each
OpeningIssue node must be an immediate child of the MapDescription node.”
EvalQuestion=“How important do you rate this issue?” />
    <TreeNodeType TYPE=“IssueArising” SortPriority=“10” ID=“IssueArising” Description=“A
further issue prompted by its parent node.” EvalQuestion=“How important do you rate this issue?” />
    <TreeNodeType TYPE=“Contention” SortPriority=“15” ID=“Contention” Description=“A
Contention states a major claim in response to its parent, which must be either an OpeningIssue
or an IssueArising.” EvalQuestion=“Taking account of all the argumentation below, how do you
rate the merit of this contention?” />
    <TreeNodeType TYPE=“Qualification” SortPriority=“15” ID=“Qualification” Description=“A
Qualification node modifies or qualifies its parent Contention.” EvalQuestion=“Taking account of
all the argumentation below, how do you rate the merit of this qualification?” />
    <TreeNodeType TYPE=“Authorizer” SortPriority=“25” IMAGEURL=“image014.gif”
ID=“Authorizer” Description=“An Authorizer node validates a particular Warrant in the current
map. If the parent Contention is excluded in a Perspective view, all its warrants are removed from
the map.” EvalQuestion=“” />
    <TreeNodeType TYPE=“Aggregator” SortPriority=“10” ID=“Aggregator”
Description=“Aggregates the inferential force of one or more argumentative points authorized by
one (or more) warrants.” EvalQuestion=“How much support (or opposition) do the argumentative
points grouped below, as authorized by the warrants, lend to the parent claim?” />
    <TreeNodeType TYPE=“SupportivePoint” SortPriority=“20” ID=“SupportivePoint”
Description=“A SupportivePoint node lends argumentative support to its parent.”
EvalQuestion=“How important do you think this point is in comparison to other points supporting
its parent?” />
    <TreeNodeType TYPE=“OpposingPoint” SortPriority=“30” ID=“OpposingPoint”
Description=“An OpposingPoint node argumentatively disputes its parent.” EvalQuestion=“How
important do you think this point is in comparison to other points supporting its parent?” />
    <TreeNodeType TYPE=“Warrant” SortPriority=“10” ID=“Warrant” Description=“A Warrant
node enunciates a broad principle which links its sibling SupportivePoint and OpposingPoint
nodes and their parent Contention.” EvalQuestion=“How do you rate the importance of this
Warrant in licensing its sibling SupportivePoint and OpposingPoint nodes?” />
    <TreeNodeType TYPE=“AlternativeWording” SortPriority=“45” ID=“AlternativeWording”
Description=“An alternative wording of the same substantive point as its parent, which a map
Administrator may promote to replace the original.” EvalQuestion=“” />
    <TreeNodeType TYPE=“CrossReference” SortPriority=“55” IMAGEURL=“image059.gif”
ID=“CrossReference” Description=“Refers to another node in the same map, or a different map.
Enables the user to jump to the specified location.” EvalQuestion=“” />
    <TreeNodeType TYPE=“Notes” SortPriority=“60” IMAGEURL=“image003.gif” ID=“Notes”
Description=“Brackets a group of user Annotations of a node.” EvalQuestion=“” />
    <TreeNodeType TYPE=“Annotation” SortPriority=“65” ID=“Annotation” Description=“A
public or private user annotation of a map node (private if in the subtree of a PrivateSpace
node).” EvalQuestion=“” />
    <TreeNodeType TYPE=“Discussion” SortPriority=“70” IMAGEURL=“image091.gif”
DEFAULTSTYLE=“font-family:Arial,Helvetica;border: 1px solid orange;background-color:beige”
Color=“beige” ID=“Discussion” Description=“A discussion area, which may include Comments,
discussion threads, Queries and Responses.” EvalQuestion=“” />
    <TreeNodeType TYPE=“Comment” SortPriority=“20” ID=“Comment” Description=“A
comment in a Discussion area, which may be stand-alone or part of a threaded discussion.”
EvalQuestion=“” />
    <TreeNodeType TYPE=“PrivateSpace” SortPriority=“90” IMAGEURL=“image048.gif”
ID=“PrivateSpace” Description=“Provides a private area for user annotations, or to develop map
structures.” EvalQuestion=“” />
    <TreeNodeType TYPE=“Deleted” SortPriority=“99” IMAGEURL=“SmallTrash.gif”
ID=“Deleted” Description=“Parking area for nodes/subtrees marked for deletion before their
permanent removal by an Administrator.” EvalQuestion=“” />
</TREENODETYPES>
```

With Reference to FIG. 27 this embodiment of the system known as the DebateMapper includes a method for beginning a new map by applying a different map grammar to the node data for an existing map. This type of map is termed a secondary map. A map with brand new data is termed a primary map. This provides a way to provide fine-grained control over how different classes of users can edit and interact by providing different editing and interaction rules in separate maps that reference the same map data. This feature is employed in the implementation of Commentator permission as described in Section 3.9 below. Users with Commentator permission are given limited, rather than full editing rights of the data of a particular map by applying a grammar enforcing such limited rights (such as adding Comment or AlternativeWording nodes only).

The key concepts are illustrated by FIG. 27. Node data 1 for a particular map is maintained in the Nodes table of the relational database. If user 4 with full editing permission for the map requests it, the Standard grammar is loaded during a map browsing and editing. However if user 5 with only Commentator permission requests it, the same node data is loaded but the Commentator grammar is applied thereby restricting the user's rights to editing moves consistent with the ‘commentator’ role.

With reference to FIG. 28 this embodiment of the system known as the DebateMapper allows subsets, or collections of subsets, of documents that have been associated with nodes to be viewed in the context of the parent document, or extracted from such context. This approach is illustrated in FIG. 28, with items 1, 2 and 3 representing the parent document, a displayed subset made up of three non-contiguous sections shown in context, and the same three sections concatenated together. The two alternative views are achieved by passing different parameters to the XML transformation used to render the subsets. The XML transformation contains conditional logic to process the two cases differently.

### Second Embodiment

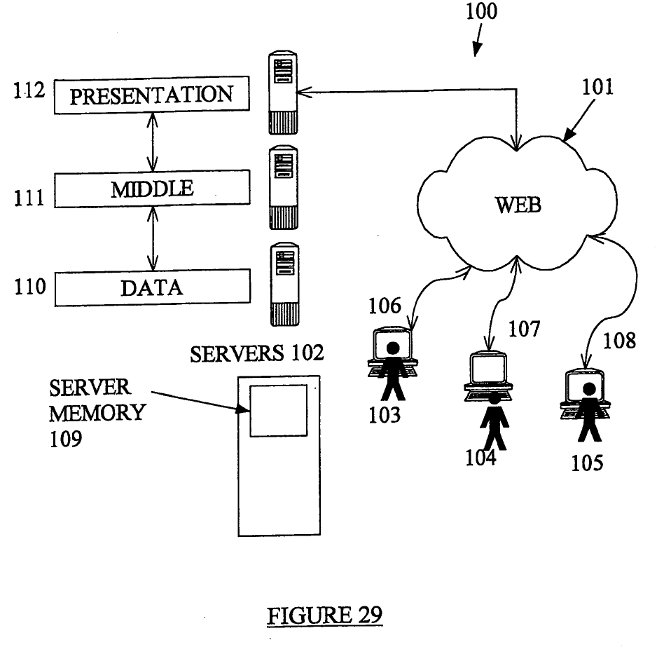

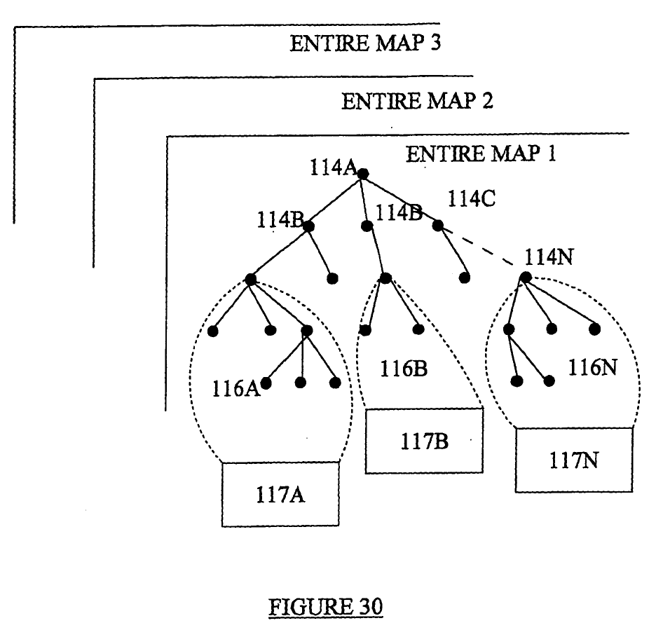

In accordance with a second preferred embodiment and with reference to FIGS. 29 and 30 there is illustrated an application of the above described first embodiment to a networked environment.

Specifically FIG. 29 illustrates a web environment 100 comprising an interconnected network of computers 101 forming at least part of what is currently termed the worldwide web.

A server 102 is in communication with web 101 such that users 103, 104, 105 can communicate with server 102 via web 101 by means of digital data processing and communication devices in this case taking the form of personal computers 106, 107, 108 respectively.

Server 102 includes a memory structure 109 comprising at least one of three code storing segments. In this instance the code storing segments comprise data storing segment 110, middle segment 111 and presentation segment 112. In a particular preferred form memory 109 services presentation 112 on a web server whilst middle segment 111 is served by a separate server cluster and data segment 110 is located on yet a separate data base server implemented for example utilizing SQL server software.

With reference to FIG. 30 a hierarchical tree structure 113 of interconnected nodes 114A, 114B, 114C . . . 114N is shown diagrammatically as forming part of first map 115. First map 115 can represent an entire argument map storing an argument structure as described with reference to the first embodiment above.

According to the second preferred embodiment this hierarchical tree structure 113 is adapted to be stored as separate discreet segments 116A, 116B . . . 116N. In this particular preferred embodiment the map segments 116A . . . 116N can be stored in corresponding memory segments 117A, 117B . . . 117N within server 102 (refer FIG. 29).

In use to implement a web enabled application for argument maps as described with reference to the first embodiment the map segments are 116A through to 116N can be stored in data segment 110 consecutively as a user navigates between nodes and in so doing moves from map segment to map segment in accordance with the rules of the map grammar. For example in moving from node 114A to node 114C map segment 116A will be replaced by map segment 116B in data segment 110 on server 102 according to the defined rules of the appropriate map grammar.

### In Use

Embodiments as described above can be utilized in an argument map context to make available to students in an educational institution a body of information organized around structural representation of major scholarly debates in such fields as history, science, philosophy and the law. Some of the classic contributions in these areas could be subjected to analysis based on their underlying argumentative structures. In this way, students and staff with access via the internet or other network would be assisted in gaining an understanding of the issues concerned.

Alternative applications can include providing decision-makers in the public policy sphere with a means of retrieving information on contentious issues that is specifically organized around the structure of argumentation of such issues, with each of the contending viewpoints able to be dissected and related to such information in a systematic way.

Further applications can include building public portals of information resources related to matters of public interest, with such portals structured around maps of debates that are of current pubic concern. Members of the public, having applied for and obtained relevant credentials, could contribute toward building map structures and associated information databases and to navigate around the map in accordance with the rules of the map grammar that are applicable to their levels of credentialing. For example some users can add comments to the information or to add nodes that present alternative wordings or other users may have full editing functionality.

### INDUSTRIAL APPLICABILITY

Embodiments of the above described system can be applied in a web environment.

1-149. (canceled)

150. A system for identifying, compressing, categorizing, visualizing, evaluating, communicating and publishing on a computer network, including the world wide web, information resources of diverse kinds structured around ordered schematic representations of arguments, debates, taxonomies, theories or other relevant meaningful structures, comprising:
a. a computer software application that enables communities of users connected to a computer network to collaboratively build, edit, navigate and view schematic representations, herein termed maps, made up of linked collections of elements herein termed nodes, that depict the meaningful structure of arguments, debates or other similar information;
b. wherein all functionality of the application is available to users with a client computer and browser software and a network connection;
c. wherein each said map conforms to a permitted set of node types, herein termed the ontology, and syntax rules that prescribe how nodes of different types may be combined into maps—such ontology and syntax rules being herein termed a map grammar;
d. wherein a plurality of said map grammars are made available reflecting, for example, but not limited to, different theories of argumentation, decision-making, taxonomy, documentation building, distinctive nomenclatures that apply in different knowledge domains, or other features relevant to various user communities;
e. wherein a user or a group of users may define, create and make available to other users a customized map grammar suitable for a particular knowledge domain, theory of argumentation or other purpose; and
f. wherein users may associate exemplars, articulations, or other relevant resources published on the world wide web or other computer network, or defined subsets or transformations of such resources, with any of said nodes, in such a way as to provide a semantic interface to such resources structured around debate, argument or other organizing principle reflected in said maps and their associated grammars.

151. The system as recited in claim 150, wherein, for each node, a set of node data is stored and maintained concerning the semantic content of the node, metadata about the node, data concerning the relation between the node and other nodes that appear in a common map(s), and a set of characteristics that determine how the node is displayed within the context of said map(s).

152. The system as recited in claim 150, wherein the user is presented with a permitted set of actions for exploring, building and editing, or otherwise interacting with such maps, their constituent nodes and any other information and resources that are associated with a map and its constituent nodes.

153. The system as recited claim 150, wherein all information pertinent to its content and structure is encoded and saved in an electronic format including, but not limited to, a set of a set of tables in a relational database or XML document(s).

154. A system of claim 150, further comprising specifying a map grammar using a computer software interface designed for this purpose, such that the rules of said map grammar are programmatically enforced as users build, edit and otherwise interact with said map(s).

155. A system of claim 150, whereby a plurality of said grammars may be applied to implementing different theories as to the structure and diagrammatical presentation of arguments and debates.

156. The system as recited in claim 150, wherein different types or levels of access to maps may be specified for different classes of users.

157. The system as recited in claim 151, wherein, for each node, the semantic content of said node may be expressed and presented in a plurality of ways varying in level of detail, compression and format.

158. The system as recited in claim 157, wherein users may select and display one or more of the plurality of expressions of a node's semantic content as recited in claim 157.

159. The system as recited in claim 150, wherein a number of maps are organized as a repository of maps.

160. The system as recited in claim 150, wherein users may build and edit maps using one or more of the following:
a. adding new nodes; or
b. editing existing nodes; or
c. deleting or permanently deleting nodes; or
d. moving a designated node and any structure made up of other nodes sitting below said designated node in the semantic tree hierarchy, herein referred to as the subtree, to a different location in the same map as said designated node, or to a location in different map, subject to any constraints encoded in any applicable map grammars applying to the maps containing the origin and destination of the moved node; or
e. copying a designated node and its subtree to a different location in the map as said designated node, or to a location in different map, subject to any constraints encoded in any applicable map grammars applying to the maps containing the origin and destination of the moved node; or
f. inserting subtrees into selected locations in maps using electronically encoded sources including, but not limited to, Extensible Markup Language (XML) documents; or
g. inserting cross-references to other nodes within any map in the repository of maps; or
h. adding a special class of node which is invisible to users other than the node author, and any subtree of which is likewise invisible.

161. The system as recited in claim 150, wherein a user can provide a single, numerical evaluation or revaluation of the significance of a node and wherein statistical data about user evaluations can be presented to users to enhance user understanding of the perceived significance of said node in the context of the map(s) in which it appears.

162. A method using the system as recited in claim 160, wherein a user is able to selectively retrieve and display particular aspects of maps using one or more of the following steps:
a. selecting a particular node in a map and retrieving other nodes to a specified depth below it in the tree structure;
b. repeating the selecting step in relation to any displayed nodes to retrieve and display as much of the map node data as desired;
c. repositioning on a map so that the displayed map portion begins at any node selected by the user, with the selected node's subtree retrieved to a specified depth;
d. repositioning on a map to the parent node of a selected node;
e. repositioning a map display so that the displayed map portion begins at a bookmarked node in any map within the containing repository of maps;
f. repositioning a map display by jumping to a cross-referenced node within the containing repository of maps;
g. repositioning a map display by jumping to a node retrieved by a text search of nodes;
h. retracing any steps as recited in claims 160a. through 160g. using navigation controls;
i. filtering in or out specified classes of nodes;
j. filtering in or out selected nodes and their sub-trees in accordance with a stated rationale;
k. choosing from a plurality of options stipulating how nodes sharing the same parent node in tree structure are ordered and displayed within the tree structure;
l. filtering in or out from a displayed map, or portion of a map, all nodes with an average evaluated significance below some value selected by a user;
m. selecting from a plurality of other map filtering criteria, including but not limited to node authorship, node creation date, original timeline, and user characteristics.

163. The system as recited in claim 150, wherein structured node data may be saved in a variety of electronic formats, including XML, or imported into a map from an external source.

164. The system as recited in claim 150, wherein a map or selected portions of maps may be rendered, saved, or printed in a variety of forms, including but not limited to a structured linear document format.

165. The system as recited in claim 150, wherein access to all functionality is governed by a role-based permission system, including one or more roles governing:
a. actions that pertain to the entire repository of maps and associated resources; or
b. actions that pertain to any specific map and its associated resources; or
c. the user's role in relation to the entire repository of maps and associated resources;
or
d. the user's role in relation to one or more particular maps.

166. The system as recited in claim 165, wherein the user:
a. applies for permissions in relation to the entire repository of maps and resources;
or
b. applies for permissions in relation to one or more particular maps; or
c. applies for changes to any existing permission levels using user interfaces designed to accommodate the applications for permission and changes.

167. The system as recited in claim 150, wherein the nodes further comprise at least one of the following additional items of information:
a. an online article; or
b. an online paper; or
c. an electric book; or
d. a web site; or
e. an image; or
f. a video; or
g. a multimedia item; or
h. a structured multimedia presentation; or
i. query results; or
j. a service; or
k. any information or service that can be addressed using a Uniform Resource Identifier (URI); or
l. any specified subset of any of the items a-k; or
m. any transformation of any of the items a-k.

168. The system as recited in claims 167, further comprising:
a. a computer interface for specifying the said subsets or the said transformations; and
b. encoding and storing a plurality of said subsets or the said transformations in a compact document separate from the original resource.

169. A method of rendering the subsets and transformations using the apparatus of claim 167, comprising performing the method on a computer connected to the web or other network either as a highlighted part of the resource or resources, or extracted and shown separately from such resources.

170. The system as recited in claim 150, wherein users may evaluate the significance of any resources associated with nodes, and wherein statistical data about user evaluations can be presented to users to enhance user understanding of the perceived significance of said resources to a node and to the map(s) in which it appears, and where such statistical data, along with other user-specified criteria, can be used to determine the way(s) in which said resources are ordered and displayed.

171. The system as recited in claim 150, wherein maps or items or services, or collations of items or services, relevant to particular nodes or maps, may be offered for sale and can be purchased by users using a marketing system, said offer including one or more of: information about the price and characteristics of the item or service, feedback and evaluations from other users, and graphic images for display advertising and web addresses etc.

172. The marketing system as recited in claim 170, wherein marketed items or services may be offered for sale in conjunction with specific nodes, resources, and/or specific maps, by various means including but not limited to purpose designed advertising nodes that can be rendered visible or not according to criteria determined by either users or advertisers.

173. A computer program package including programming instructions for implementing a system for semantically organizing and categorizing information and associated resources published on a computer network, including the world wide web, in accordance with the meaningful structure of debates and arguments comprising:
a. a computer software application that enables communities of users connected to a computer network to collaboratively build, edit, navigate and view schematic representations, herein termed maps, made up of linked collections of elements herein termed nodes, that depict the meaningful structure of arguments, debates or other similar information;
b. wherein all functionality of the application is available to users with a client computer and browser software and a network connection;
c. wherein each said map conforms to a permitted set of node types, herein termed the ontology, and syntax rules that prescribe how nodes of different types may be combined into maps—such ontology and syntax rules being herein termed a map grammar;
d. wherein a plurality of said map grammars are made available reflecting, for example, but not limited to, different theories of argumentation, decision-making, taxonomy, documentation building, distinctive nomenclatures that apply in different knowledge domains, or other features relevant to various user communities;
e. wherein a user or a group of users may define, create and make available to other users a customized map grammar suitable for a particular knowledge domain, theory of argumentation or other purpose; and
f. wherein users may associate exemplars, articulations, or other relevant resources published on the world wide web or other computer networks, or defined subsets or transformations of such resources, with any of said nodes, thereby providing a semantic interface to such resources structured around debate, argument or other organizing principle reflected in said maps and their associated grammars.

174. A digitized media package for implementing a system for semantically organizing and categorizing information and associated resources published on a computer network, including the world wide web, in accordance with the meaningful structure of debates and arguments comprising:
a. a computer software application that enables communities of users connected to a computer network to collaboratively build, edit, navigate and view schematic representations, herein termed maps, made up of linked collections of elements herein termed nodes, that depict the meaningful structure of arguments, debates or other similar information.
b. the said computer software application wherein all functionality of the application is available to users with a client computer and browser software and a network connection.
c. the said computer software application wherein each said map conforms to a permitted set of node types, herein termed the ontology, and syntax rules that prescribe how nodes of different types may be combined into maps—such ontology and syntax rules being herein termed a map grammar.
d. the said computer software application wherein a plurality of said map grammars are made available reflecting, for example, but not limited to, different theories of argumentation, decision-making, taxonomy, documentation building, distinctive nomenclatures that apply in different knowledge domains, or other features relevant to various user communities.
e. the said computer software application wherein a user or a group of users may define, create and make available to other users a customized map grammar suitable for a particular knowledge domain, theory of argumentation or other purpose.
f. the said computer software application wherein users may associate exemplars, articulations, or other relevant resources published on the world wide web or other computer networks, or defined subsets or transformations of such resources, with any of said nodes, thereby providing a semantic interface to such resources structured around debate, argument or other organizing principle reflected in said maps and their associated grammars.

175. A digitized system for implementing a method for semantically organizing and categorizing information and associated resources published on a computer network, including the world wide web, in accordance with the meaningful structure of debates and arguments comprising:
a. a computer software application that enables communities of users connected to a computer network to collaboratively build, edit, navigate and view schematic representations, herein termed maps, made up of linked collections of elements herein termed nodes, that depict the meaningful structure of arguments, debates or other similar information;
b. wherein all functionality of the application is available to users with a client computer and browser software and a network connection;
c. wherein each said map conforms to a permitted set of node types, herein termed the ontology, and syntax rules that prescribe how nodes of different types may be combined into maps—such ontology and syntax rules being herein termed a map grammar;
d. wherein a plurality of said map grammars are made available reflecting, for example, but not limited to, different theories of argumentation, decision-making, taxonomy, documentation building, distinctive nomenclatures that apply in different knowledge domains, or other features relevant to various user communities;
e. wherein a user or a group of users may define, create and make available to other users a customized map grammar suitable for a particular knowledge domain, theory of argumentation or other purpose; and
f. wherein users may associate exemplars, articulations, or other relevant resources published on the world wide web or other computer networks, or defined subsets or transformations of such resources, with any of said nodes, thereby providing a semantic interface to such resources structured around debate, argument or other organizing principle reflected in said maps and their associated grammars.

176. A digitized application for implementing a system for semantically organizing and categorizing information and associated resources published on a computer network, including the world wide web, in accordance with the meaningful structure of debates and arguments comprising:
a. a computer software application that enables communities of users connected to a computer network to collaboratively build, edit, navigate and view schematic representations, herein termed maps, made up of linked collections of elements herein termed nodes, that depict the meaningful structure of arguments, debates or other similar information;
b. the said computer software application wherein all functionality of the application is available to users with a client computer and browser software and a network connection;
c. the said computer software application wherein each said map conforms to a permitted set of node types, herein termed the ontology, and syntax rules that prescribe how nodes of different types may be combined into maps—such ontology and syntax rules being herein termed a map grammar;
d. the said computer software application wherein a plurality of said map grammars are made available reflecting, for example, but not limited to, different theories of argumentation, decision-making, taxonomy, documentation building, distinctive nomenclatures that apply in different knowledge domains, or other features relevant to various user communities;
e. the said computer software application wherein a user or a group of users may define, create and make available to other users a customized map grammar suitable for a particular knowledge domain, theory of argumentation or other purpose; and
f. the said computer software application wherein users may associate exemplars, articulations, or other relevant resources published on the world wide web or other computer networks, or defined subsets or transformations of such resources, with any of said nodes, thereby providing a semantic interface to such resources structured around debate, argument or other organizing principle reflected in said maps and their associated grammars.
